(19) United States
(12) Patent Application Publication
(10) Pub. No.: US 2026/0145086 A1
(43) Pub. Date: May 28, 2026

(54) METHOD FOR INTERACTION PROCESSING IN A VIRTUAL SCENE, DEVICE, APPARATUS, COMPUTER-READABLE STORAGE MEDIUM, AND COMPUTER PROGRAM PRODUCT

(71) Applicant: Hangzhou Pawprint Interactive Entertainment Technology Co., Ltd., Hangzhou (CN)

(72) Inventor: Yingwu ZHONG, Hangzhou (CN)

(21) Appl. No.: 19/330,207

(22) Filed: Sep. 16, 2025

(30) Foreign Application Priority Data
Nov. 4, 2024 (CN) 202411562858.7

(51) Int. Cl. A63F 13/825; A63F 13/52; A63F 13/537; A63F 13/63

(52) U.S. Cl. CPC A63F 13/825; A63F 13/52; A63F 13/537; A63F 13/63

(57) ABSTRACT

A method for interaction processing in a virtual scene, a device, and a non-transitory computer-readable storage medium are provided. The method includes: displaying a virtual scene in a human-computer interaction interface, herein the virtual scene includes a first player character; in response to a fusion operation, synthesizing the first player character and a first virtual pet of the first player character into a second virtual pet having a first ability, herein the first ability includes at least one of a perception ability and a movement ability of the first virtual pet; in response to the second virtual pet being located in a first target scene corresponding to the first ability, displaying an interaction picture that the second virtual pet uses the first ability for the first target scene.

### CROSS-REFERENCE TO RELATED APPLICATION

This application is based on and claims the benefit of priority to Chinese Patent Application No. 202411562858.7, filed Nov. 4, 2024, entitled “METHOD FOR INTERACTION PROCESSING IN A VIRTUAL SCENE, DEVICE, APPARATUS, COMPUTER-READABLE STORAGE MEDIUM, AND COMPUTER PROGRAM PRODUCT”, which is herein incorporated by reference in its entirety.

### TECHNICAL FIELD

The present disclosure relates to human-computer interaction technology, and more particularly to a method for interaction processing in a virtual scene, a device, an apparatus, a storage medium, and a program product.

### BACKGROUND

The display technology based on graphics processing hardware expands the channels of perceiving the environment and obtaining information, especially the display technology of virtual scenes, which may implement diversified interactions between the virtual objects controlled by users or artificial intelligence according to actual application requirements, and there are various typical application scenarios. For example, in the virtual scene of games, it may simulate the real battle process between the virtual characters.

In the process that the target account (player) controls the player character to perform interaction in a virtual scene, in order to improve the diversity and interest of interaction, the related art usually introduces a non-player character (such as virtual pet) into the virtual scene, and control the non-player character to use their own special abilities such as movement ability and perception ability to assist the player character to interact in a special scene. However, in this interaction manner, the player character only passively benefits from the special ability of the non-player character and cannot experience the special ability personally, which reduces the immersion for the player character.

### SUMMARY

The embodiments of the present disclosure provide a method for interaction processing in a virtual scene, an electronic device, and a non-transitory computer-readable storage medium.

The technical solution of the embodiment of the disclosure is implemented as follows.

The embodiments of the present disclosure provide a method for interaction processing in a virtual scene. The method includes: displaying the virtual scene in a human-computer interaction interface, herein the virtual scene includes a first player character; in response to a fusion operation, synthesizing the first player character and a first virtual pet of the first player character into a second virtual pet having a first ability, herein the first ability includes at least one of a perception capability or a movement ability of the first virtual pet; and in response to the second virtual pet being located in a first target scene corresponding to the first ability, displaying an interaction picture that the second virtual pet uses the first ability for the first target scene.

The embodiments of the present disclosure provide an electronic device. The electronic device includes a memory and a processor. The memory is configured to store computer executable instructions or a computer program. The processor is configured to: when performing the computer executable instructions or the computer program stored in the memory, implement the method for interaction processing in a virtual scene provided by the embodiments of the present disclosure.

The embodiments of the present disclosure provide a computer-readable storage medium having stored thereon computer-executable instructions or a computer program which, when performed by a processor, implement the method for interaction processing in a virtual scene provided by the embodiments of the present disclosure.

### BRIEF DESCRIPTION OF THE DRAWINGS

FIG. 1 is a schematic diagram of an architecture of a system 100 for interaction processing in a virtual scene according to an embodiment of the present disclosure.

FIG. 2 is a schematic structural diagram of an electronic device 500 according to an embodiment of the present disclosure.

FIG. 3 is a schematic flow diagram of a method for interaction processing in a virtual scene according to an embodiment of the present disclosure.

FIG. 4 is a schematic diagram of the fusion according to an embodiment of the present disclosure.

FIG. 5 is a first schematic diagram of an appearance configuration for a second virtual pet to be synthesized according to an embodiment of the present disclosure.

FIG. 6 is a second schematic diagram of an appearance configuration for a second virtual pet to be synthesized according to an embodiment of the present disclosure.

FIG. 7 is a schematic diagram of an ability configuration for a second virtual pet to be synthesized according to an embodiment of the present disclosure.

FIG. 8 is a first schematic diagram of a comparison of the view pictures according to an embodiment of the present disclosure.

FIG. 9 is a second schematic diagram of a comparison of the view pictures according to an embodiment of the present disclosure.

FIG. 10 is a third schematic diagram of a comparison of the view pictures according to an embodiment of the present disclosure.

### DETAILED DESCRIPTION

In order to make the object, technical solution and advantages of the present disclosure more clear, the present disclosure will be described in further detail below with reference to the accompanying drawings. The described embodiments should not be regarded as limiting the present disclosure, and all other embodiments obtained by those ordinary skilled in the art without inventive efforts belong to the scope of protection of the present disclosure.

It is to be understood that in the embodiments of the present disclosure, the related data such as user information is involved, and when the embodiments of the present disclosure are applied to specific products or technologies, the permission or consent of the user is required, and the collection, use and processing of the related data need to comply with relevant laws, regulations and standards.

In the following description, reference is made to “some embodiments” that describe a subset of all possible embodiments. However, it is to be understood that “some embodiments” may be the same subset or different subsets of all possible embodiments and may be combined with each other without conflict.

In the following description, the referred terms “first/second . . . ” are merely used to distinguish similar objects, and do not represent a particular order for the objects. It is to be understood that “first/second . . . ” may be interchanged in a particular order or sequence where allowed, such that the embodiments of the disclosure described herein may be implemented in an order other than that illustrated or described herein.

In the embodiments of the present disclosure, the term “module” or “unit” refers to a computer program having a predetermined function or a portion of the computer program, and works together with other relevant parts to implement a predetermined object, and may be implemented in whole or in part by using software, hardware (such as processing circuitry or memory), or a combination thereof. Likewise, a processor (or a plurality of processors or a memory) may be used to implement one or more modules or units. Furthermore, each module or unit may be a portion of an overall module or unit that contains the functions of the module or unit.

Unless otherwise defined, all technical and scientific terms used herein have the same meanings as are commonly understood by those skilled in the art of the present disclosure. Terms used herein are for the purpose of describing the embodiments of the disclosure only and are not intended to limit the present disclosure.

Before further describing the embodiments of the present disclosure in detail, the terms and terminologies referred in the embodiments of the present disclosure will be described, and the terms and terminologies referred in the embodiments of the present disclosure are applicable to the following explanations.
1) Client: an application program running in a terminal for providing various services, such as a video playback client, a game client, etc.
2) In response to: indicating a condition or state on which the operation to be performed depends, one or more operations to be performed may be in real time or may have a preset delay when the dependent condition or state is satisfied. Unless otherwise specified, there is no limitation on the order of execution of a plurality of operations to be performed.
3) The virtual scene is a virtual scene displayed (or provided) when the application program runs on the terminal. The virtual scene may be a simulation environment of the real world, a semi-simulated and semi-fictional virtual environment, or a purely fictional virtual environment. The virtual scene may be any one of a two-dimensional virtual scene, a 2.5-dimensional virtual scene, or a three-dimensional virtual scene, and the dimension of the virtual scene is not limited in the embodiments of the present disclosure. For example, the virtual scene may include sky, land, sea, etc., the land may include the environmental elements such as desert and city, and the user may control the virtual object to move in the virtual scene.
4) Virtual character: avatars of various people and objects that may interact with each other in the virtual scene, or a movable object in the virtual scene. The movable object may be a virtual person, a virtual animal, an animation character, etc., such as a person, an animal, or the like displayed in the virtual scene. The virtual character may be an invented digital avatar used to represent a user in the virtual scene, and the virtual scene may include a plurality of virtual characters, and each virtual character has its own shape and volume in the virtual scene and occupies a portion of the space in the virtual scene.

In the practical applications, the virtual character may be classified into a player character and a non-player character according to whether it is controlled by a user (or player). The player character is a game character controlled by the user (or player), and the non-player character is a game character not controlled by the user (or player), such as an animal-type Non-Player Character (NPC) (such as an elf or a pet), and the player character and the non-player character may interact with each other in the virtual scene.
5) Movement ability refers to the movement ability that the virtual character has when facing a special moving scene. Especially in the virtual scene application, the non-player character (i.e. virtual pet) usually has some special movement abilities, for example, climbing ability in a climbing scene such as trees and hillsides, swimming ability in a wading scene such as rivers and seas, jumping ability or flying ability in a non-contact moving scene, etc.
6) Perception ability refers to the ability that the player character or non-player character receives external information through senses and interpret, understand and process the information, which includes but not limited to: auditory ability (including auditory sensory ability and auditory perception ability, i.e., the ability of perception and recognition of sound), visual ability (including visual sensory ability and visual perception ability, i.e., perception of light and color, and recognition of shape, size, distance, depth and movement), olfactory ability (including olfactory sensory ability and olfactory perception ability, i.e., the perception and recognition of smells), gustatory ability (including gustatory sensory ability and gustatory perception ability, i.e., the perception and identification of tastes), and tactile ability (including tactile sensory ability and tactile perception capacity, i.e., the sensation of touch, pressure, temperature, texture, etc.).

In the virtual scene application, there may be a difference in perception abilities of the non-player character (i.e. virtual pet) and the player character. For example, the non-player character may have the perception ability for expanding the field of view (e.g. bilateral field of view or greater radius of field of view), perception ability with night vision function, perception ability with special hearing ability (for example, the non-player character may be sensitive to certain sounds, or able to hear sounds that the player character cannot hear), perception ability with detection function (for example, the non-player character may perceive the intention or emotion of the player character or detect the player character or virtual object in hidden state). In some virtual environments, the non-player characters may also have a special olfactory ability and be capable to detect the smell of player character or other clues.

The embodiments of the present disclosure provide a method for interaction processing in a virtual scene, a device, an electronic device, a computer-readable storage medium, and a computer program product, which may improve the immersion of interaction for the player character. An exemplary application of the electronic device provided by the embodiment of the present disclosure will be described below. The electronic device provided by the embodiment of the present disclosure may be implemented as various types of user terminal, such as a notebook computer, a tablet computer, a desktop computer, a set-top box, a mobile device (for example, a mobile phone, a portable music player, a personal digital assistant, a dedicated messaging device, a portable game device), a smart phone, a smart speaker, a smart watch, a smart television, an in-vehicle terminal, an Augmented Reality (AR) device, and a Virtual Reality (VR) device, or may be implemented as a server. Hereinafter, an exemplary application that the device is implemented as a terminal will be described.

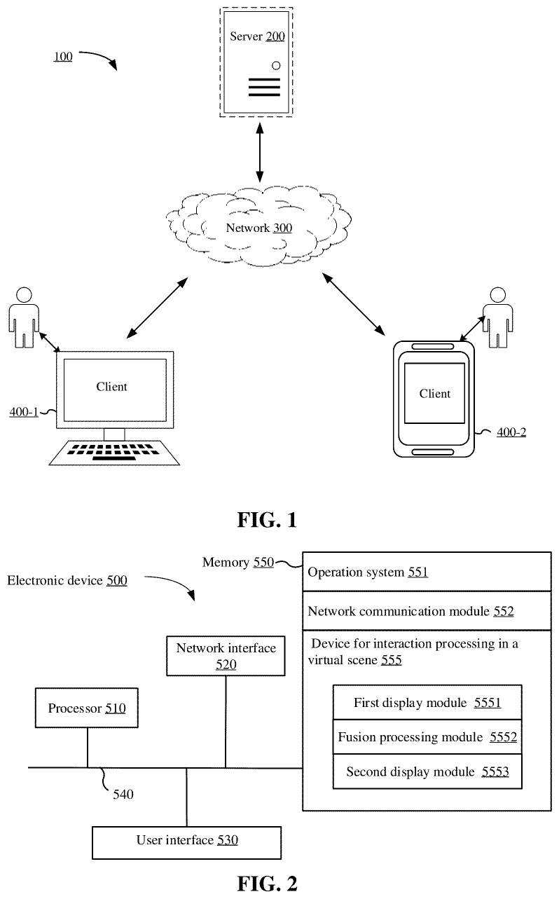

Referring to FIG. 1, FIG. 1 is a schematic diagram of an architecture of a virtual scene interaction system 100 according to an embodiment of the present disclosure. In order to support an exemplary application, the terminals (a terminal 400-1 and a terminal 400-2 are exemplarily illustrated) are connected to the server 200 through the network 300, and the network 300 may be a wide area network or a local area network, or a combination thereof.

In some embodiments, the terminal is provided with a client, such as a video playback client, an instant messaging client, a game client, a live broadcast client, etc. The server 200 is a background server corresponding to the client, and may be an independent physical server, a server cluster or distributed system composed of a plurality of physical servers, or a cloud server that provides basic cloud computing services such as cloud service, cloud database, cloud computing, cloud function, cloud storage, network service, cloud communication, middleware service, domain name service, security service, Content Delivery Network (CDN), and big data and artificial intelligence platform. The terminal and the server may be directly or indirectly connected by wired or wireless communication, which is not limited in the embodiments of the present disclosure.

In the practical application, the terminal displays the virtual scene in the human-computer interaction interface. The virtual scene includes a first player character. A fusion request is transmitted to the server 200 in response to the fusion operation. Based on the fusion request, the server 200 determines a first virtual pet owned by the first player character to be fused, synthesizes the first player character and the first virtual pet into a second virtual pet having a first ability, and returns the second virtual pet obtained by fusing to the terminal. The terminal displays the second virtual pet obtained by fusing in the virtual scene, and in response to the second virtual pet being located in the first target scene corresponding to the first ability, displays an interaction picture that the second virtual pet uses the first ability for the first target scene.

Referring to FIG. 2, FIG. 2 is a schematic structural diagram of an electronic device 500 provided by an embodiment of the present disclosure. Taking the electronic device 500 being the terminal in FIG. 1 as an example, the electronic device 500 shown in FIG. 2 includes: at least one processor 510, a memory 550, at least one network interface 520, and a user interface 530. The various components in the electronic device 500 are coupled together via a bus system 540. It is to be understood that the bus system 540 is configured to implement the connection communication among these components. In addition to the data bus, the bus system 540 further includes a power bus, a control bus and a status signal bus. However, the various buses are marked as bus system 540 in FIG. 2 for clarity.

The processor 510 may be an integrated circuit chip with the capability of signal processing, such as a general purpose processor, a Digital Signal Processor (DSP) or other programmable logic device, a discrete gate or transistor logic device, a discrete hardware component or the like. The general purpose processor may be a microprocessor or any conventional processor, or the like.

The memory 550 includes the volatile memory or the non-volatile memory, and may also include both the volatile and the non-volatile memory. The non-volatile memory may be a Read Only Memory (ROM), and the volatile memory may be a Random Access Memory (RAM). The memory 550 described in the embodiments of the present disclosure is intended to include any suitable type of memory. Optionally, the memory 550 includes one or more storage devices physically located remotely from the processor 510.

In some embodiments, the memory 550 is capable of storing data to support various operations, and the examples of these data include programs, modules, and data structures, or subsets or supersets thereof, as exemplarily described below.

The operating system 551 includes the system programs for processing various basic system services and performing hardware-related tasks, such as a framework layer, a core library layer, a driver layer, and is configured to implement various basic services and process hardware-based tasks. The network communication module 552 is configured to reach other electronic devices via one or more (wired or wireless) network interfaces 520, and the exemplary network interface 520 includes Bluetooth, Wireless Fidelity (WiFi), and Universal Serial Bus (USB), etc.

In some embodiments, the device for interaction processing in the virtual scene provided by the embodiment of the present disclosure may be implemented in a software manner, and the device for interaction processing in the virtual scene provided by the embodiment of the present disclosure may be provided in various software embodiments, including various forms such as application programs, software, software modules, scripts, or codes. FIG. 2 illustrates the device 555 for interaction processing in a virtual scene stored in the memory 550. The device 555 for interaction processing may be a software in the form of programs and plug-ins, and includes a series of modules, which include a first display module 5551, a fusion processing module 5552 and a second display module 5553. These modules are logical and can therefore be arbitrarily combined or further split according to the implemented functions. The functions of each module will be described below.

In some other embodiments, the device provided by the embodiment of the present disclosure may be implemented in a hardware manner. As an example, the device provided by the embodiment of the present disclosure may be a processor in the form of a hardware coding processor, and is programmed to perform the method for interaction processing in the virtual scene provided by the embodiment of the present disclosure. For example, the processor in the form of hardware coding processor may use one or more application-specific integrated circuits (ASICs), digital signal processors (DSPs), programmable logic devices (PLDs), complex programmable logic devices (CPLDs), field-programmable gate arrays (FPGAs), or other electronic components.

In some embodiments, the terminal or the server may implement the method for interaction processing in the virtual scene provided by the embodiment of the present disclosure by running various computer-executable instructions or computer programs. For example, the computer-executable instructions may be microprogram-level commands, machine instructions, or software instructions. The computer program may be a native program or software module in the operating system. It may be a Native Application (APP), i.e., a program that needs to be installed in the operating system to be run, such as a game APP. It may also be a mini program that can be embedded in any APP, i.e., a program that only needs to be downloaded to the browser environment to be run. In summary, the computer-executable instruction described above may be any form of instruction, and the computer program described above may be any form of application program, module, or plug-in.

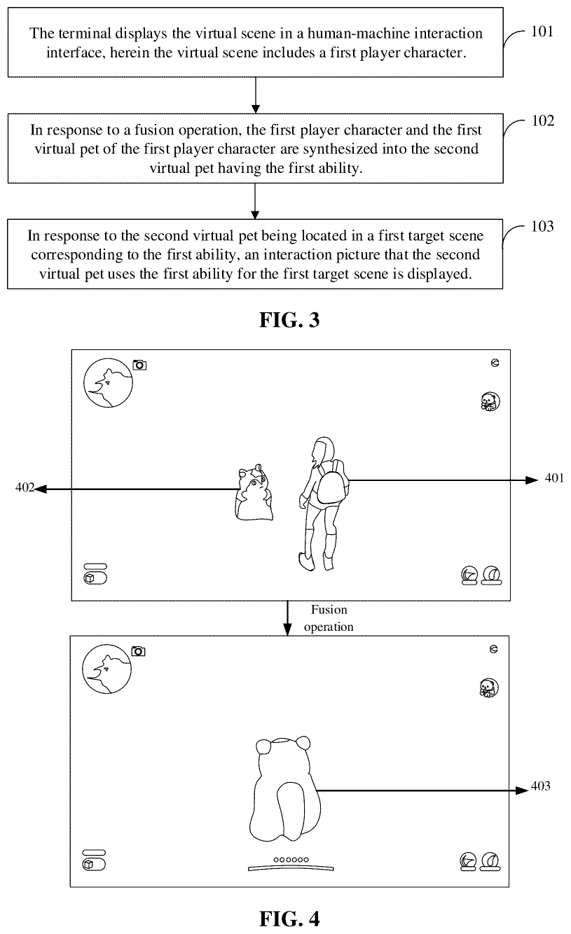

As described above, the method for interaction processing in the virtual scene provided by the embodiments of the present disclosure may be implemented by various types of electronic devices. For example, the method may be performed by any one of the terminal or the server 200 in FIG. 1 alone, or may be performed together by the terminal and the server 200 in FIG. 1. Next, the description will be made by taking the method for interaction processing in the virtual scene provided by the embodiments of the present disclosure being performed by the terminal in FIG. 1 alone as an example. Referring to FIG. 3, FIG. 3 is a schematic flow diagram of a method for interaction processing in a virtual scene according to an embodiment of the present disclosure. The description will be made in combination with the steps illustrated in FIG. 3.

At step 101, the terminal displays the virtual scene in a human-computer interaction interface, herein the virtual scene includes a first player character.

In the practical application, a client supporting a virtual scene is installed in the terminal (for example, when the virtual scene is a game, the corresponding client may be a game APP), and when the user opens the client installed in the terminal and the terminal runs the client, the virtual scene may be displayed in the human-computer interaction interface of the client, and a first player character controlled by a target account (i.e., the account corresponding to the current terminal) may be displayed in the virtual scene. The target account may control the first player character to perform various interactions in the virtual scene, such as controlling the first player character to move, to pick up the virtual prop, and to cast the virtual ability in the virtual scene.

In addition, when the first player character owns a virtual pet, the virtual pet owned by the first player corner may be displayed in the virtual scene, and when the first player character owns a plurality of virtual pets, all or part of the virtual pets owned by the first player character may be displayed in the virtual scene. The virtual pet owned by the first player character may follow the first player character to interact in the virtual scene, and the first player character and the virtual pet owned by the first player character may also perform interaction with each other in various ways. For example, the first player character may interact with the virtual pet through text or voice, the first player character may instruct the virtual pet to pick up the virtual prop or exchange the virtual prop, the virtual pet may provide related services to the first player character (such as providing treatment service, virtual prop pickup service, or virtual prop transport service to the first player character), and so on.

At step 102, in response to a fusion operation, the first player character and the first virtual pet of the first player character are synthesized into the second virtual pet having the first ability.

The first ability includes at least one of a perception ability or a movement ability of the first virtual pet.

In the practical application, the terminal may, in response to the fusion operation, fuse the first player character and the first virtual pet owned by the first player character into the second virtual pet according to the interaction requirement of the first player character in the virtual scene.

That is, the second virtual pet represents the first player character. Since the second virtual pet (i.e., the first player character after transformation) has at least one of the perception ability or movement ability of the first virtual pet as its first ability, as such, the second virtual pet (i.e., the first player character after transformation) may experience interaction using the first ability in the target scene adapted to the first ability. This enhances the immersion of the first player character when experiencing the first ability of the first virtual pet.

The above-mentioned fusion operation may be actively triggered by the player (the fusion operation is a passive fusion operation for the terminal), or it may be automatically triggered by the terminal based on the interaction requirement of the first player character in the virtual scene without being actively triggered by the player. Next, various triggering modes will be described.

In some embodiments, the terminal may synthesize the first player character and the first virtual pet of the first player character into the second virtual pet having the first ability in response to the fusion operation by following manners. A pet list is displayed, and at least one first virtual pet belonging to the first player character is displayed in the pet list. In response to the selection operation triggered based on the pet list, the selected first virtual pet is highlighted. In response to the fusion operation for the first player character and the selected first virtual pet, the first player character and the selected first virtual pet are fused into a second virtual pet having the first ability.

In the practical application, when the first player character owns the first virtual pet, a pet list may also be displayed in the virtual scene during the of the process that the first player character performs interaction in the virtual scene. The pet list displays one or more (two or more) first virtual pets owned by the first player character, and when the player selects one or more first virtual pets, the selected first virtual pet may be highlighted (e.g., displayed with highlight, displayed with special color, etc.) to distinguish it from the unselected first virtual pet. After the player selects the first virtual pet, a fusion operation for the first player character and the selected first virtual pet may be triggered, and the terminal may fuse the first player character and the selected first virtual pet into the second virtual pet in response to the fusion operation.

The fusion operation is a related operation actively triggered by the player for instructing the fusion of the first player character and the selected first virtual pet, and there are various manners for triggering the fusion operation. For example, the player may trigger the fusion operation by triggering the fusion control, by entering a voice that instructs the fusion of the first player character and the selected first virtual pet, or by making a spatial gesture that instructs the fusion of the first player character and the selected first virtual pet. Of course, the player may also trigger the fusion operation through other manners, and the embodiments of the present disclosure do not limit the triggering manners for the fusion operation.

It is to be understood that in some embodiments, when the first player character owns a virtual pet, the fusion control may also be displayed in the virtual scene when the first player character performs interaction in the virtual scene. When the player triggers the fusion control, the terminal displays a pet list in the virtual scene in response to the triggering operation, and the pet list displays one or more (two or more) first virtual pets owned by the first player character. When the player selects one or more first virtual pets, it triggers the fusion operation that fuses the first player character with the selected first virtual pet. That is, in response to the fusion operation, the terminal synthesizes the first player character and the selected first virtual pet into the second virtual pet.

In some embodiments, the terminal may display at least one first virtual pet belonging to the first player character in the pet list by following operations. A plurality of first virtual pets belonging to the first player character are displayed in the pet list by using the target sorting when there are a plurality of first virtual pets. The target order is sorted according to one of the following characteristic parameters of the first virtual pet: a historical summoning frequency, a historical fusion frequency, a matching degree of a first ability possessed by the first virtual pet with the environment in which the first player character is currently located, or an attribute value of the skill of the first virtual pet.

In the practical application, when the first player character has a plurality of first virtual pets, the fusion priorities of different first virtual pets are generally different. The first virtual pets may be displayed in corresponding display styles according to the fusion priorities of the first virtual pets. That is, according to the fusion priorities of the first virtual pets, the first virtual pets may be displayed in different display styles (such as different display sequences, different display colors, different display brightness, different display fonts, etc.), or the first virtual pets with higher fusion priorities are highlighted, which may facilitate the player in selecting the required first virtual pet to perform fusion, and enhance the pertinence and efficiency of fusion.

For example, in a case where the first player character has a plurality of first virtual pets, the plurality of first virtual pets belonging to the first player character are displayed in the pet list in a target order. The target order is sorted according to a characteristic parameter related to the first virtual pet. The characteristic parameter may include a historical summoning frequency for the first virtual pet (i.e., the frequency or the number of times that the first player character summons the first virtual pet into the virtual scene). Generally, the greater the historical summoning frequency for the first virtual pet, the higher the fusion priority of the first virtual pet, and accordingly, the first virtual pet is displayed earlier in the pet list. The characteristic parameter may also include a historical fusion frequency of the first virtual pet (i.e., a frequency or the number of times that the first player character is fused with the first virtual pet within a historical target time). Generally, the greater the historical fusion frequency of the first virtual pet, the higher the fusion priority of the first virtual pet, and accordingly, the first virtual pet is displayed earlier in the pet list. The characteristic parameter may further include an attribute value (attack ability, defense ability, speed, stamina, mana point, etc.) of the skill of the first virtual pet. In general, the greater the attribute value of the skill of the first virtual pet, the higher its fusion priority, and accordingly, the first virtual pet is displayed earlier in the pet list.

The characteristic parameter may also include a matching degree between the first ability of the first virtual pet and the environment in which the first player character is currently located. Generally, the greater the matching degree, the higher the fusion priority of the first virtual pet accordingly, and the first virtual pet is displayed earlier in the pet list. The matching degree may be obtained by performing prediction based on the ability characteristic (i.e., the ability type, such as climbing ability, swimming ability, flying ability, ability for expanding the field of view, night vision ability, detection ability, etc.) of the first ability possessed by the first virtual pet and the scene characteristic (i.e., the scene type, such as climbing scene for the hillside type, swimming scene for the wading type, non-contact flying scene, dark scene, scene with an obstacle existed, etc.) of the scene in which the first player character is currently located by calling the third machine learning model. The third machine learning model is trained as follows. Based on the ability feature of the ability owned by the sample virtual pet and the scene feature of the environment in which the sample player character is currently located, the third machine learning model is invoked to compute a prediction matching degree. Backpropagation is then performed by using the difference between the prediction matching degree and the actual matching result label (1 for matching, 0 for mismatching) to update the parameters of the third machine learning model. For example, after determining the value of the loss function of the third machine learning model based on the difference between the prediction matching degree and the actual matching result label (1 for matching, 0 for mismatching), it may be determined whether the value of the loss function exceeds the preset threshold value. When the value of the loss function exceeds the preset threshold value, an error signal of the third machine learning model is determined based on the loss function, the error signal is backpropagated in the third machine learning model, and the model parameter of each layer is updated during the propagation process.

The model structure of the machine learning model (including the third machine learning model and the following first machine learning model and second machine learning model) is not limited in the embodiments of the present disclosure. For example, the machine learning model may be a convolutional neural network, a deep neural network, etc. The form of the loss function is also not limited, and may be, for example, a cross-entropy loss function, an L2 loss function, etc. The backpropagation is described herein. The training sample data is input into the input layer of the neural network model, passes through the hidden layer, and finally reaches the output layer to output the result. This is the forward propagation process of the neural network model. Since there is an error between the output result of the neural network and the actual value, the error between the output result and the actual value is calculated, and this error is then propagated backward from the output layer through the hidden layer until it reaches the input layer. During the backpropagation progress, the model parameters are adjusted based on the error. That is, a loss function is constructed according to the error between the output result and the actual value, and the partial derivative of the loss function with respect to the model parameter is computed layer by layer, to generate the gradient for the partial derivative with respect to the parameter of each layer. Since the direction of the gradient indicates the direction that the error increases, the gradient of the model parameter is negated and summed with the original parameter of each layer. The obtained sum serves as the updated parameter for each layer, thereby reducing the error caused by the model parameters. The above-mentioned process is iterated until it converges.

In some embodiments, that the terminal may, in response to the fusion operation, synthesizes the first player character and the first virtual pet of the first player character into the second virtual pet having the first ability by following manners. In response to an automatic fusion condition being satisfied, the first player character and the first virtual pet of the first player character are synthesized into the second virtual pet having the first ability. The automatic fusion condition includes any one of followings: a use operation performed by the first player character for a virtual prop having a fusion function is received; an interaction operation of the first player character with a first target scene is received; the first player character moves to the first target scene and a matching degree between the first player character having the first ability and the first target scene is greater than a matching degree between the first player character not having the first ability and the first target scene; or an interaction progress of the first player character in the virtual scene reaches a first target progress.

In the practical application, the automatic fusion condition may be configured in advance. In this way, during the interaction process of the first player character in the virtual scene, if the automatic fusion condition is satisfied, an automatic fusion operation may be triggered, and the terminal synthesizes the first player character and the first virtual pet of the first player character into a second virtual pet having the first ability in response to the automatic fusion operation.

For example, a virtual prop or a virtual skill with a fusion function (that is, capable of triggering a fusion operation) may be configured in advance, and an automatic fusion operation may be triggered when the player character uses the virtual prop or the virtual skill, as such when the first player character uses the virtual prop or the virtual skill in a virtual scene, the terminal may determine that the automatic fusion condition is satisfied, and trigger the automatic fusion operation.

For another example, a target scene with a fusion function (that is, capable of triggering the fusion operation) may be configured in advance, and it is further configured that the automatic fusion operation may be triggered when the player character interacts with the target scene, as such when the first player character interacts with the target scene, if the terminal receives the interaction operation between the first player character and the target scene, the terminal determines that the automatic fusion condition is satisfied, and triggers the automatic fusion operation. The target scene generally refers to the scene (including the first target scene) that may trigger the automatic fusion operation. That is, in this configuration, the player character interacts with a specific scene, such as touching a mysterious statue, entering a special area, etc., to trigger the automatic fusion operation.

For another example, it may be configured in advance that when the matching degree between the player character and the target scene (including the first target scene) is less than the matching degree threshold, the automatic fusion operation is triggered, and the automatic fusion operation instructs that the first player character is transformed into the second virtual pet with the first ability (essentially, the first player character after transformation has the first ability), and the matching degree between the first player character having the first ability and the target scene reaches the matching degree threshold. Therefore, when the first player character moves to the first target scene, the terminal determines automatically the matching degree between the first player character and the first target scene based on the character feature (such as the attribute values of various skills (including attack ability, defense ability, speed, stamina, mana point, etc.) owned by the first player character) and the scene feature (i.e., the scene type, such as climbing scene for the hillside type, swimming scene for the wading type, non-contact flying scene, dark scene, scene with an obstacle, etc.). When the matching degree between the first player character and the first target scene is less than the matching degree threshold, it is determined that the automatic fusion condition is satisfied, and the automatic fusion operation is triggered to transform the first player character into the second virtual pet having the first ability, and the matching degree between the second virtual pet having the first ability and the first target scene is greater than the matching degree threshold.

For another example, it may be configured in advance that the automatic fusion operation will be triggered when the interaction progress of the player character in the virtual scene reaches the first target progress. That is, as the interaction progress advances, if the interaction duration of the first player character in the virtual scene reaches the target time, or the interaction achievement of the first player character in the virtual scene reaches the achievement threshold, the automatic fusion operation may be triggered to control the first player character to automatically transform into the virtual pet.

According to the above manners, the terminal may trigger the automatic fusion operation according to the interaction of the first player character in the virtual scene, and it is not required the player to actively trigger the fusion operation, such that that the first player character and the first virtual pet are synthesized to the second virtual pet, thereby improving the intelligence and efficiency of the fusion transformation of the player character.

In some embodiments, the terminal may implement the operation that the first player character and the first virtual pet of the first player character are synthesized into the second virtual pet having the first ability in response to the fusion operation by following manners. In a case where only one first virtual pet of the first player character is currently included in the virtual scene, the first player character and the first virtual pet currently included in the virtual scene are synthesized into the second virtual pet having the first ability in response to the fusion operation. In a case where a plurality of first virtual pets of the first player character are currently included in the virtual scene, in response to a pet selection operation, the first player character and the selected first virtual pet are synthesized into the second virtual pet having the first ability, and the first ability is the first ability of the selected first virtual pet. When the first player character has a plurality of first virtual pets, the first player character and the first virtual pet screened from the plurality of first virtual pets are synthesized into the second virtual pet having the first ability in response to the automatic fusion operation, the screened first virtual pet is obtained by sorting and screening in a descending order based on the screening parameter, and the screening parameter is determined based on at least one of following characteristic parameters: a historical summoning frequency, a historical fusion frequency, a matching degree between the first ability of the first virtual pet and an environment in which the first player character is currently located, or an attribute value of the skill of the first virtual pet.

In the practical application, referring to FIG. 4, FIG. 4 is a schematic diagram of the fusion provided by the embodiment of the present disclosure. In a case where only one first virtual pet 402 of the first player character 401 is currently included in the virtual scene, the terminal may synthesize the first player character and the first virtual pet currently included in the virtual scene into the second virtual pet 403 having the first ability in response to the fusion operation (which may be a passive fusion operation or an automatic fusion operation). The appearance of the second virtual pet 403 may be an appearance of the first virtual pet 402, and may also be an appearance unrelated to the appearance of the first virtual pet 402. In this case, the second virtual pet acquires the first ability of the first virtual pet, which is currently the only one included in the virtual scene.

It is to be noted that in the fusion transformation process, a fusion transformation special effect may be displayed to enrich the fusion transformation process. Moreover, if the first player character further owns another first virtual pet (this first virtual pet is not displayed in the screen of the virtual scene), the player may trigger another first virtual pet in the pet list to update the second virtual pet to the fourth virtual pet which is obtained by fusing the first player character and the triggered another first virtual pet in the pet list.

In a case where a plurality of first virtual pets of a first player character are currently included in the virtual scene, different first virtual pets have different first abilities, and the player may select a first virtual pet to be fused from the plurality of first virtual pets. For example, the terminal controls the first virtual pets to be in a selectable state in response to a trigger operation for the fusion control, displays the ability identifiers of the first abilities possessed by the first virtual pets, triggers the fusion operation (that is, the pet selection operation may be regarded as a passive fusion operation) in response to the pet selection operation triggered based on the ability identifier, and synthesizes the first player character and the selected first virtual pet (the number of selected first virtual pets may be one or more) into the second virtual pet. In this case, the second virtual pet obtains the first ability of the selected first virtual pet. In this way, the player may select the first virtual pet to be fused according to the actual requirements, which improves the pertinence and initiative for the transformation of the player character in the process of the fusion transformation.

In a case where a plurality of first virtual pets of the first player character are currently included in the virtual scene, the terminal may further automatically screen out the first virtual pet from the plurality of first virtual pets in response to the automatic fusion operation, and synthesize the first player character and the screened first virtual pet to the second virtual pet. In this case, the second virtual pet obtains the first ability of the first virtual pet that the terminal automatically screens out. Different first virtual pets have different first abilities, and the fusion priorities of different first virtual pets are generally different, and the first virtual pets may be sorted in a descending order according to the fusion priorities of the first virtual pets. The fusion priorities are determined based on a screening parameter, and the screening parameter may include a historical summoning frequency for the first virtual pet (i.e., the frequency or times that the first player character summons the first virtual pet into the virtual scene). Generally, the greater the historical summoning frequency for the first virtual pet, the higher the fusion priority of the first virtual pet, and accordingly, the higher the ordering of the first virtual pet. The characteristic parameter may further include a historical fusion frequency for the first virtual pet (i.e., a frequency or times that the first player character is fused with the first virtual pet within a historical target time period). Generally, the greater the historical fusion frequency of the first virtual pet, the higher the fusion priority of the first virtual pet, and accordingly, the higher the ordering of the first virtual pet. The characteristic parameter may further include an attribute value (attack ability, defense ability, speed, physical stamina, magic points, etc.) of the skill of the first virtual pet. In general, the greater the attribute value of the skill of the first virtual pet, the higher the fusion priority of the first virtual pet, and accordingly, the higher the ordering of the first virtual pet.

The characteristic parameter may further include a matching degree between the first ability of the first virtual pet and the environment in which the first player character is currently located. Generally, the greater the matching degree, the higher the fusion priority of the first virtual pet accordingly, and the higher the ordering of the first virtual pet. The matching degree may be obtained by performing prediction by calling the third machine learning model based on the ability characteristic (i.e., the ability type, such as climbing ability, swimming ability, flying ability, ability for expanding the field of view, night vision ability, detection ability, etc.) of the first ability possessed by the first virtual pet and the scene characteristic (i.e., the scene type, such as climbing scene for the hillside type, swimming scene for the wading type, non-contact flying scene, dark scene, scene with an obstacle, etc.) of the scene in which the first player character is currently located. It may improve the accuracy of the matching degree prediction. In this way, the terminal automatically fuses the first player character with the first virtual pet most needed for current interaction, thereby improving the efficiency and intelligence of the fusion.

In some embodiments, the terminal may synthesizes the first player character and the first virtual pet of the first player character into the second virtual pet having the first ability in response to the fusion operation by following manner. In response to the fusion operation, the first player character and the first virtual pet of the first player character are synthesized into the second virtual pet having the first ability and a first appearance. A size and a skin of the second virtual pet with the first appearance satisfy any one of following conditions: the size of the second virtual pet is greater than a size of the first virtual pet, herein a magnification of the size of the second virtual pet relative to the size of the first virtual pet represents an efficacy magnification of the second virtual pet using the first ability of the first virtual pet relative to the first ability of the first virtual pet; the skin of the second virtual pet is same as a skin of the first virtual pet; the skin of the second virtual pet is obtained by merging a skin of the first player character and the skin of the first virtual pet; or when the first player character is fused with a plurality of first virtual pets, the skin of the second virtual pet is dynamically changed with a first virtual pet to which a currently used first ability belongs.

In the practical application, the terminal controls the second virtual pet synthesized with the first player character and the first virtual pet to have a first appearance, and the first appearance is formed based on at least the appearance (i.e. skin) of the first virtual pet participating in the fusion. For example, the first appearance may be the appearance of the first virtual pet. That is, the skin of the second virtual pet may be same as the skin of the first virtual pet. For another example, the first appearance may be obtained by merging the appearance of the first virtual pet participating in the fusion and the appearance of the first player character, such that the appearance of the second virtual pet has both the appearance feature of the first player character and the appearance feature of the first virtual pet, thereby making the second virtual pet recognizable. That is, the second virtual pet, as displayed with the first appearance, may be recognized as being formed by fusion of the first player character and the first virtual pet. For example, assuming that the second virtual pet with the first appearance is obtained by merging the first player character, the first virtual pet 1 and the first virtual pet 2, the second virtual pet not only inherits the attribute and interaction ability of the first player character, but also the first ability of the first virtual pet 1 and the first ability of the first virtual pet 2 (the first ability of the first virtual pet 1 and the first ability of the first virtual pet 2 may be the same or different). The first appearance of the second virtual pet may be obtained by merging the appearances (skins) of the first player character, the first virtual pet 1, and the first virtual pet 2. For example, the head of the second virtual pet may have the feature of the head of the first player character, the body of the second virtual pet has the feature of the body of the first virtual pet 1, and the tail of the second virtual pet has the feature of the tail of the first virtual pet 2. It may be recognized that the second virtual pet is merged by the first player character, the first virtual pet 1, and the first virtual pet 2 through the appearance of the second virtual pet.

When there are a plurality of first virtual pets participating in the fusion, the first appearance may also be dynamically changed. That is, the currently displayed skin (i.e., the first appearance) of the second virtual pet changes following the change of the first virtual pet to which the first ability currently used by the second virtual pet belongs. For example, taking the second virtual pet with the first appearance being obtained by merging the first player character, the first virtual pet 1 and the first virtual pet 2 as an example, if the first ability used by the second virtual pet with the first appearance at the first time is the first ability of the first virtual pet 1, the first appearance displayed at the first time is the appearance of the first virtual pet 1. If the first ability used by the second virtual pet with the first appearance at the second time is the first ability of the first virtual pet 2, the first appearance displayed at the second time is the appearance of the first virtual pet 2. If the second virtual pet with the first appearance does not use the first ability at the third time, the first appearance displayed at the third time is the appearance of the first player character.

According to the above manners, the dynamically changed first appearance makes the first ability currently used by the secondary virtual pet recognizable. That is, it may be recognized whether the second virtual pet is currently using the first ability through the currently displayed first appearance of the second virtual pet. Furthermore, when the first ability is in use, the first virtual pet, of which the first ability is inherited by the first ability in use, may be recognized from the first virtual pets participating in fusion. In this way, not only the diversity and entertainment of fusion transformation may be improved, but also the player may have an intuitive understanding of the first virtual pet to which the ability currently used by the second pet belongs, thereby providing a more immersive interactive experience for the player.

In a case where the first appearance of the second virtual pet is formed based on the appearance of the first virtual pet participating in the fusion (for example, the skin of the second virtual pet is same as the skin of the first virtual pet), the size of the second virtual pet may be the same or different from the size of the first virtual pet. In a case where the size of the second virtual pet is different from the size of the first virtual pet, for example, when the size of the second virtual pet is greater than the size of the first virtual pet, the magnification of the size of the second virtual pet with respect to the first virtual pet is used to represent the efficacy magnification of the second virtual pet with respect to the first virtual pet.

For example, assuming that the first ability of the first virtual pet is a movement ability for climbing a mountain (i.e., climbing ability), the climbing speed of the first virtual pet for climbing a mountain by using the first ability (climbing ability) is v. If the magnification factor of the size of the second virtual pet with respect to the first virtual pet is 1.5, it indicates that the climbing speed of the second virtual pet for climbing a mountain by using the first ability is 1.5 times the climbing speed of the first virtual pet for climbing a mountain by using the first ability. That is, the climbing speed of the second virtual pet for climbing a mountain by using the first ability is 1.5v.

For another example, assuming that the first ability of the first virtual pet is a perception ability for expanding the field of view, the field of view observed by the first virtual pet using the first ability is twice the field of view observed by the first virtual pet not using the first ability. If the magnification factor of the size of the second virtual pet with respect to the first virtual pet is 1.5, it indicates that the magnification factor of the field of view observed by the second virtual pet using the first ability is 1.5 times the magnification factor of the field of view observed by the first virtual pet using the first ability. That is, the field of view observed by the second virtual pet using the first ability is 3 times (2*1.5=3) the field of view observed by the second virtual pet not using the first ability.

According to the above manners, the player may intuitively perceive the gain brought by using the first ability after the fusion transformation according to the size relationship between the size of the second virtual pet and the first virtual pet, which is beneficial to improving the enthusiasm of the player to use the fusion transformation function.

In some embodiments, the terminal may synthesize the first player character and the first virtual pet of the first player character into the second virtual pet having the first ability in response to the fusion operation by following manner. In response to the fusion operation, an appearance entry for configuring the appearance of the second virtual pet is displayed. In response to an appearance configuration operation triggered based on the appearance entry, the appearance of the second virtual pet is configured to be a second appearance. In response to the determining operation for the second appearance, the first player character and the first virtual pet of the first player character are synthesized into the second virtual pet with the first ability and the second appearance.

In the actual application, the terminal may also pop up an appearance entry in response to the fusion operation, configure the appearance of the synthesized second virtual pet as the second appearance through the appearance entry, and synthesize the first player character and the first virtual pet into the second virtual pet with the first ability and the second appearance. The second appearance may or may not be related to the appearance of the first virtual pet, so that the synthesized second virtual pet has the first ability of the first virtual pet. Moreover, in the case where the second appearance is not related to the appearance of the first virtual pet, the display style of the second virtual pet is enriched, thereby improving the motility and freedom for the player to configure the visual appearance of the synthesized second virtual pet during the fusion transformation process.

In some embodiments, the terminal may configure the appearance of the second virtual pet as the second appearance in response to the appearance configuration operation triggered based on the appearance entry by following manner. In response to the trigger operation for the appearance entry, an appearance selection interface is displayed, and at least one candidate appearance is displayed in the appearance selection interface. In response to the selection operation for the second appearance of the at least one candidate appearance, the appearance of the second virtual pet is configured as the second appearance.

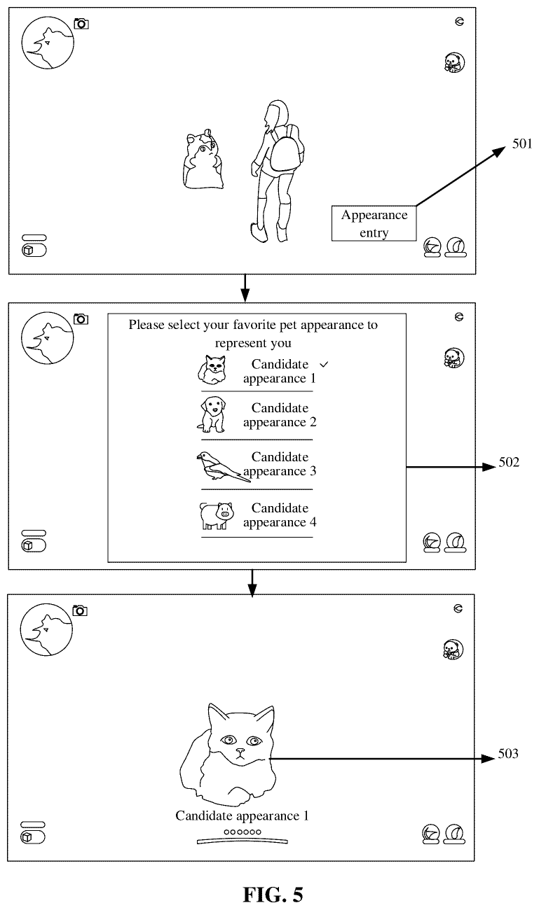

Referring to FIG. 5, FIG. 5 is a first schematic diagram of an appearance configuration for a second virtual pet to be synthesized according to an embodiment of the present disclosure. When the player triggers the appearance entry 501, the terminal displays the appearance selection interface 502 in response to the trigger operation, and displays one or more candidate appearances (such as candidate appearance 1, candidate appearance 2, candidate appearance 3, and candidate appearance 4) that may be selected in the appearance selection interface 502. These candidate appearances may be same as or different from the appearance of the first virtual pet owned by the first player character, and the player may select an appropriate candidate appearance therefrom based on the actual requirements as the corresponding appearance of the synthesized second virtual pet. For example, if the player selects candidate appearance 4, the second appearance of the finally synthesized second virtual pet 503 is the candidate appearance 4. In this way, the mobility and freedom to configure the appearance style of the synthesized second virtual pet for the player in the process of fusion and transforming are improved.

In some embodiments, the terminal may configure the appearance of the second virtual pet as the second appearance in response to the appearance configuration operation triggered based on the appearance entry by following manner. An appearance configuration interface is displayed in response to the trigger operation for the appearance entry, and at least one appearance label is displayed in the appearance configuration interface. In response to the selection operation for the target appearance label, the appearance of the second virtual pet is configured as a second appearance generated based on the target appearance label.

In the practical application, when the player triggers the appearance entry, the terminal may not display the existing candidate appearance in response to the trigger operation, but display one or more selectable appearance labels, the appearance label indicates the type or appearance of the second virtual pet to be synthesized, such as a mount type (an animal or a vehicle), a pet type (a cat or a dog, etc.), a hair color, a pet gender, a dress or decoration worn by the pet, etc., from which the player may select one or more target appearance labels. In response to the selection operation for the target appearance label, the terminal generates the second appearance that conforms to the target appearance label based on the target appearance labels selected by the player, thereby synthesizing the first player character and the first virtual pet into the second virtual pet with the second appearance.

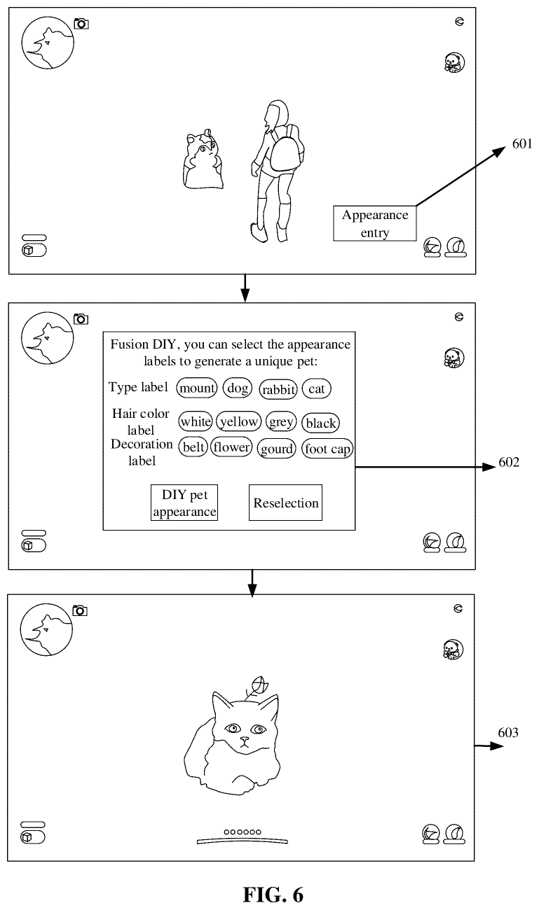

Referring to FIG. 6, FIG. 6 is a second schematic diagram of an appearance configuration for a second virtual pet to be synthesized according to an embodiment of the present disclosure. When the player triggers the appearance entry 601, in response to the trigger operation, the terminal displays an appearance configuration interface 602, and displays one or more appearance labels that may be selected in the appearance configuration interface 602, such as a type label (such as mount, dog, rabbit, cat, etc.), a hair color label (such as white, yellow, gray, black, etc.), a decoration label (such as belt, flower, gourd, foot cap, etc.). If the player selects the following target appearance labels: cat, white, flower, the terminal displays the second appearance generated based on the target appearance labels in the preview interface 603 in response to the selection operation for the target appearance labels, such as a white cat wearing a flower. When the player triggers a confirmation operation for the second appearance based on the preview interface, this determination operation may serve as an appearance configuration operation to configure the second appearance as the appearance of the second virtual pet to be synthesized. In this case, the terminal synthesizes the first player character and the first virtual pet into the second virtual pet with the second appearance (i.e., a white cat wearing a flower) in response to the fusion operation.

According to the above manners, the user may customize and design the appearance of the second virtual pet to be synthesized according to the actual requirement, which further improves the initiative and freedom for the player to configure the appearance style for the second virtual pet to be synthesized.

In some embodiments, the terminal may synthesize the first player character and the first virtual pet of the first player character into the second virtual pet having the first ability in response to the fusion operation by following manner. In response to the fusion operation, an ability configuration interface is displayed, and at least one ability label is displayed in the ability configuration interface. In response to the label selection operation, the first player character and the first virtual pet of the first player character are synthesized into the second virtual pet having a first ability and a third ability, and the third ability is the ability indicated by the selected ability label.

Referring to FIG. 7, FIG. 7 is a schematic diagram of an ability configuration for a second virtual pet to be synthesized according to an embodiment of the present disclosure. In response to the fusion operation, the terminal may also pop up the ability configuration interface, through which the ability of the second virtual pet to be synthesized may be additionally configured. For example, the ability labels (climbing, wading, flying, jumping, night vision, detection, etc.) are displayed in the ability configuration interface, and the player may select one or more ability labels from the ability labels. In response to the label selection operation, the terminal synthesizes a second ability based on the ability label selected by the player, and synthesizes the first player character with the first virtual pet of the first player character to the second virtual pet having the first ability and the third ability. For example, assuming that the first ability of the first virtual pet is climbing ability (a type of movement ability) and the ability labels selected by the player are night vision and detection, the second ability synthesized based on the selected labels includes night vision ability and detection ability. Then the final synthesized second virtual pet not only has the first ability (i.e. climbing ability) of the first virtual pet participating in the fusion, but also has the second ability (i.e. night vision ability and detection ability) custom synthesized by the player.

According to the above manners, the user may customize the ability of the second virtual pet to be synthesized according to the actual requirement, which further expands the ability range of the finally synthesized second virtual pet, and improves the initiative and freedom for the player to configure the ability for the second virtual pet to be synthesized. Furthermore, when the interaction is performed based on the synthesized second virtual pet, the experience immersion for the player for various abilities such as the first ability and the customized ability of the first virtual pet is improved.

At step 103, in response to the second virtual pet being located in a first target scene corresponding to the first ability, an interaction screen of the second virtual pet with the first ability for the first target scene is displayed.

In the actual application, after the first player character is transformed into the second virtual pet having the first ability, if the second virtual pet is located in the first target scene in which the first ability needs to be used, an interaction picture that the second virtual pet uses the first ability for the first target scene may be displayed, so that the player may switch and experience the interaction situation with the first ability in the first target scene from the perspective of the second virtual pet, and the immersion of the player in experiencing the first ability of the first virtual pet in the first target scene may be improved.

In some embodiments, the terminal may display the interaction picture that the second virtual pet uses the first ability for the first target scene by following manner. In response to the first target scene being a moving scene and the first ability being a moving ability adapted to the moving scene, a picture that the second virtual pet moves in the moving scene with the moving ability is displayed.

In the practical application, when the first target scene is a moving scene and the first ability is a moving ability adapted to the moving scene, that is, when the matching degree between the ability characteristic of the first ability and the scene characteristic of the first target scene is greater than a matching degree threshold value, the second virtual pet may be controlled to move in the moving scene with the moving ability (i.e., the first ability) and a corresponding moving picture is displayed. For example, when the first target scene is climbing scene (such as a mountain or a tree) and the first ability is climbing ability, the terminal may control the second virtual pet to climb with the climbing ability in the climbing scene, and the climbing picture is displayed. For another example, when the first target scene is a wading scene (such as a river or a sea) and the first ability is a swimming ability, the terminal may control the second virtual pet to swim with the swimming ability in the wading scene, and a swimming picture is displayed. For another example, when the first target scene is a non-contact flying scene and the first ability is a flying ability, the terminal may control the second virtual pet to fly with the flying ability in the flying scene, and a flying picture is displayed.

According to the above manners, the player may personally experience the interaction with the moving ability of the first virtual pet in the moving scene, and the experience immersion of the player for the moving ability of the first virtual pet is improved.

In some embodiments, before the terminal synthesizes the first player character and the first virtual pet into the second virtual pet having the first ability, in response to the first player character being located in the first target scene, a first view picture observed by the first player character for the first target scene is displayed. Accordingly, the terminal may display an interaction picture that the second virtual pet uses the first ability for the first target scene by following manner. In response to the first ability being a perception ability for expanding the field of view, a second view picture observed by the second virtual pet with the perception ability for the first target scene is displayed. The field of view of the second view picture is greater than the field of view of the first view picture.

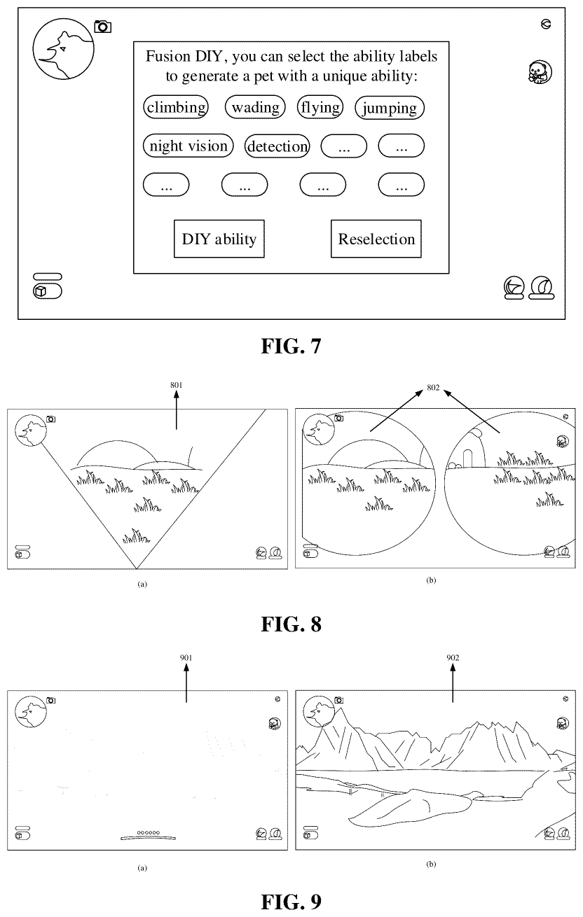

Referring to FIG. 8, FIG. 8 is a first schematic diagram of a comparison of the view pictures according to an embodiment of the present disclosure. (a) illustrates a first view picture 801 observed by the first player character for the first target scene before the first player character is fused and transformed into the second virtual pet, and (b) illustrated a second view picture 802 observed by the second virtual pet with a first ability for the first target scene after the first player character is fused and transformed into the second virtual pet. Assuming that the first ability is a perception ability for expanding the field of view, such as binocular perspective perception ability, the second view picture 802 is the lateral view and rearward view observed by the second virtual pet with the binocular perspective perception ability for the first target scene. Therefore, the field of view of the second view picture 802 is greater than the field of view of the first view picture 801. For example, the field of view of the first view picture 801 is 75 degrees, while the field of view of the second view picture 802 is close to 360 degrees. This enables the first player character to observe the surrounding environment from the perspective of the second virtual pet by using the first ability of the first virtual pet to observe the surrounding environment almost without blind spots, thereby greatly improving the immersion of the player in experiencing the perceptual ability of expanding the field of view.

In some embodiments, before the terminal synthesizes the first player character and the first virtual pet into the second virtual pet having the first ability, in response to the first player character being located in the first target scene, a third view picture observed by the first player character for the first target scene is displayed. Accordingly, the terminal may display the interaction picture that the second virtual pet uses the first ability for the target scene by following manner. In response to the first ability being a perception ability with a night vision function, a fourth view picture observed by the second virtual pet with the perception ability for the first target scene is displayed. Herein a visibility of the third view picture is lower than a visibility of the fourth view picture.

Referring to FIG. 9, FIG. 9 is a second schematic diagram of a comparison of the view pictures according to an embodiment of the present disclosure. (a) illustrates a third view picture 901 observed by the first player character for the first target scene before the first player character is fused and transformed. (b) illustrates a fourth view picture 902 observed by the second virtual pet using the first ability for the first target scene after the first player character is fused and transformed into the second virtual pet. Assuming that the first target scene is a dimly lit scene and the first ability is a perception ability with night vision, the visibility of the first target scene for the first player character in the third view picture illustrated in (a) is lower than the visibility threshold for the first target scene. In the fourth view picture illustrated in (b), the visibility of the first target scene for the second virtual pet having the first ability is higher than the visibility threshold for the first target scene, which enables the first player character to clearly observe the scene information in the first target scene by using the first ability (perception ability with night vision function) of the first virtual pet from the perspective of the second virtual pet, and greatly improves the immersion of the player in experiencing this perception ability with night vision function.

In some embodiments, before the terminal synthesizes the first player character and the first virtual pet into the second virtual pet having the first ability, in response to the first player character being located in the first target scene and there being a virtual object which is occluded in the first target scene, a fifth view picture observed by the first player character for the first target scene is displayed. Accordingly, the terminal may display an interaction picture that the second virtual pet uses the first ability for the first target scene by following manner. In response to the first ability being a perception ability with a detection function, a sixth view picture that the second virtual pet uses the perception ability for the virtual object is displayed. Herein the virtual object in the fifth view picture is in an invisible state for the first player character, and the virtual object in the sixth view picture is in a visible state for the second virtual pet.

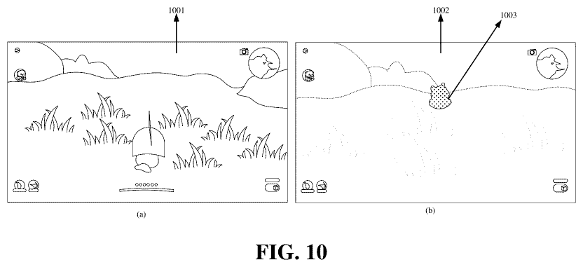

Referring to FIG. 10, FIG. 10 is a third schematic diagram of a comparison of the view pictures according to an embodiment of the present disclosure. (a) illustrates a fifth view picture 1001 observed by the first player character for the first target scene before the first player character is fused and transformed. (b) illustrates a sixth view picture 1002 observed by the second virtual pet using the first ability for the first target scene after the first player character is fused and transformed into the second virtual pet. Assuming that there is a virtual object which is occluded (i.e., any invisible unit within the virtual scene, such as a treasure chest hidden by the wall, or an invisible path) in the first target scene, and the first ability is a perception ability with detection function, since the first player character does not have the perception ability with detection function, the occluded virtual object in the fifth view picture illustrated in (a) is invisible to the first player character. Since the second virtual pet has the perception ability with detection function, the occluded virtual object 1003 in the sixth picture illustrated in (b) is visible to the first player character, which enables the first player character to clearly observe, from the perspective of the second virtual pet, the scene information that would otherwise be invisible in the first target scene by using the first ability (perception ability with detection function) of the first virtual pet, and greatly improves the immersion of the player in experiencing the perception ability with detection function.

In some embodiments, the terminal may display the interaction picture that the second virtual pet uses the first ability for the first target scene by following manner. In a case where the first player character is synthesized with a plurality of first virtual pets to obtain the second virtual pet, an interaction picture that the second virtual pet uses the combination ability for the first target scene is displayed. The combination ability is determined by following manners: it is obtained by combining the first ability of each of the plurality of first virtual pet; it is obtained by combining a representative ability of first abilities of each of the plurality of first virtual pets; the usage probability of each combination ability is calculated based on the characteristics of the plurality of candidate combination abilities of the plurality of first virtual pets by calling the first machine learning model, and the combination ability with the maximum usage probability is selected. The first machine learning model is trained by following manner. The first machine learning model prediction is called based on the features of a plurality of combination ability samples to obtain a probability of each combination ability, and the backpropagation is performed based on a difference between the probability of each combination ability and an actual selection result label to update the parameter of the first machine learning model.

In the practical application, in a case where the first player character is fused with a plurality of first virtual pets to obtain the second virtual pet, the first ability acquired by the second virtual pet may be a combination ability of the first abilities of the first virtual pets, which participate in the fusion transformation, in the plurality of first virtual pet. For example, the first virtual pets participating in the fusion include the first virtual pet 1 having climbing ability, the first virtual pet 2 having detection ability and night vision ability, and the first virtual pet 3 having swimming ability. When the first virtual pet participating in the fusion has a plurality of different first abilities, the combination ability may be obtained by selecting a representative first ability from a plurality of first abilities of each first virtual pet to perform combination. For example, if the first virtual pets participating in the fusion include the first virtual pet 1 having climbing ability and jumping ability (the representative ability is climbing ability), the first virtual pet 2 having detection ability and night vision ability (the representative ability is detection ability), and the first virtual pet 3 having swimming ability and climbing ability (the representative ability is swimming ability), the combination ability acquired by the synthesized second virtual pet includes the climbing ability of the first virtual pet 1, the detection ability of the first virtual pet 2 and the swimming ability of the first virtual pet 3.

In addition, when the first player character is fused with a plurality of first virtual pets to obtain the second virtual pet, the first abilities of the plurality of first virtual pets may be combined into a plurality of candidate combination abilities by permutation and combination, and the feature of each candidate combination ability (such as ability type, scene in which the ability acts, ability effective duration or cooling duration, etc.) is obtained, the first machine learning model is called to calculate the usage probability of each candidate combination ability, and the candidate combination ability with the maximum usage probability is selected as the combination ability of the synthesized second virtual pet. The first machine learning model is trained by following manner. The first machine learning model is called to perform prediction based on the features of a plurality of combination ability samples to obtain the probability of each combination ability, the backpropagation is performed based on the difference between the probability of each combination ability and the actual selection result label (for example, 1 for selection, 0 for not used) to update the parameter of the first machine learning model. For example, after the value of the loss function for the first machine learning model is determined based on the difference between the predicted probability of each combination ability sample and the actual selection result label, it may be determined whether the value of the loss function exceeds a preset threshold. When the value of the loss function exceeds the preset threshold, an error signal for the first machine learning model is determined based on the loss function. This error signal is backpropagated in the first machine learning model, the model parameter of each layer is updated during the propagation process.

It may be understood that when a plurality of first virtual pets have the same first ability, the combination ability may be a simple superposition of the same first ability of the first virtual pets, or may be a multiplicative superposition of the same first ability of the first virtual pets.

According to the above method, after the first player character and the plurality of first virtual pets are fused and transformed into the second virtual pet, the second virtual pet acquires the combination ability of the first abilities of the plurality of first virtual pets, which expands the ability range of the second virtual pet. In this way, when the interaction is performed with the combination ability based on the synthesized second virtual pet, the experience immersion of the player for the combination ability is improved.

In some embodiments, the terminal may display the interaction picture that the second virtual pet uses the first ability for the first target scene by following manner. An interaction picture that the second virtual pet uses the first ability for the first target scene is displayed. Herein the efficacy that the second virtual pet uses the first ability is the same as or has a first gain coefficient with respect to the efficacy that the first virtual pet uses the first ability.

In the practical application, the first player character and the first virtual pet are fused and transformed into the second virtual pet, so that after the second virtual pet acquires the first ability of the first virtual pet, the efficacy that the second virtual pet uses the first ability is the same as the efficacy that the first virtual pet uses the first ability, or has a certain first gain coefficient (preset by the server or set by the player account corresponding to the first player object) with respect to the efficacy that the first virtual pet uses the first ability. For example, when the first ability is a moving ability for climbing a mountain (i.e., climbing ability), the climbing speed of the first virtual pet to climb the mountain by using the first ability is v, and the climbing speed of the second virtual pet to climb the same mountain by using the first ability may be v or 1.5v (i.e., the first gain coefficient is 1.5v/v=1.5). For another example, when the first ability is a perception ability for expanding the field of view, the field of view observed by the first virtual pet by using the first ability is twice the field of view observed by the first virtual pet without using the first ability, and the field of view observed by the second virtual pet using the first ability may be three times (that is, the first gain coefficient is 3/2=1.5) the field of view observed by the second virtual pet without using the first ability (that is, the first player character does not use the first ability). In this way, it is beneficial to improve the motivation of players to use the fusion transformation function.

In some embodiments, after the terminal displays the interaction picture that the second virtual pet uses the first ability for the first target scene, when the first player character has a plurality of first virtual pets, in response to a fusion update condition being satisfied, the second virtual pet is updated to a third virtual pet having a second ability. The third virtual pet is obtained by synthesizing the first player character with a new first virtual pet, the new first virtual pet is one of the plurality of first virtual pets, and the second ability is a first ability possessed by the new first virtual pet. The fusion update condition includes at least one of the followings: a fusion update operation is received, herein the fusion update operation indicates fusing the first player character with a new first virtual pet; the second virtual pet moves to the second target scene, and the matching degree between the second ability and the second target scene is greater than the matching degree between the first ability and the second target scene; or the interaction progress of the second virtual pet in the virtual scene reaches the second target progress, and the interaction progress includes at least one of: an interaction duration or an interaction achievement, that is, when the interaction duration of the second virtual pet in the virtual scene reaches a preset time, or when the interaction achievement of the second virtual pet in the virtual scene reaches a preset achievement, it is determined that the update condition is satisfied.

In the practical application, when the first player character has a plurality of first virtual pets, different first virtual pets have different first abilities, and in the process that the second virtual pet performs interaction by using the first ability in the virtual scene, the second virtual pet may be updated to a third virtual pet having the second ability when the fusion update condition is satisfied with the advancement of the interaction or the change of the target scene. Herein the third virtual pet is obtained by synthesizing the first player character and the new first virtual pet.

For example, after the second virtual pet moves from the first target scene to the second target scene, the first ability possessed by the second virtual pet is no longer adapted to the second target scene (for example, the matching degree between the first ability and the second target scene is lower than the matching degree threshold), at this case, the first player character and the new first virtual pet need to be synthesized into the third virtual pet having the second ability. The second ability is the ability owned by the new first virtual pet. The matching degree between the second ability and the second target scene exceeds the matching degree threshold, so that the newly synthesized third virtual pet is more suitable for the second target scene in which the player is located. The method for determining the matching degree between the first ability and the second target scene and the matching degree between the second ability and the second target scene are same as the method for determining the matching degree between the first ability and the environment in which the first player character is currently located, which will not be elaborated here.

It is to be noted that, in a case where there are a plurality of new first virtual pets for fusion and a plurality of original first virtual pets for fusion (i.e., the first virtual pets participating in the synthesis of the second virtual pet), the plurality of new first virtual pets for fusion are at least partially different from the plurality of original first virtual pets. For example, part of the original first virtual pets whose matching degree with the environment in which the second virtual pet is located is lower than the preset threshold value are replaced by part of the new first virtual pets, such that the matching degree between the new synthesized third virtual pet and the current environment is greater than the preset threshold value.

In some embodiments, after the terminal synthesizes the first player character and the first virtual pet of the first player character into the second virtual pet having the first ability, in response to an interaction trigger operation for the second virtual pet, the terminal controls the second virtual pet to cast the skill of the first virtual pet. The interaction target of the skill includes at least one of: a virtual object in the virtual scene, a non-player character in the virtual scene, or a second player character in the virtual scene, and the second player character is different from the first player character.

In the practical application, after the first player character and the first virtual pet are synthesized into the second virtual pet such that the second virtual pet has the first ability of the first virtual pet, the second virtual pet may also acquire the skill of the first virtual pet, the player may trigger an interaction trigger operation for the second virtual pet, and the terminal may control the second virtual pet to cast the skill of the first virtual pet to an interaction target in response to the interaction trigger operation. The interaction target may be any interactable object within the virtual scene, such as the virtual object (e.g., virtual props, virtual gems, etc.) in the virtual scene, the non-player character or the second player character in the virtual scene. When the second player character and the first player character are in a cooperation teammate relationship, if the second virtual pet casts the skill of the first virtual pet onto the second player character, it may bring beneficial effects (such as increasing the health points, enhancing attack ability, etc.) to the second player character. When the second player character and the first player character are in a hostile relationship, if the second virtual pet casts the skill of the first virtual pet to the second player character, it may bring a debuff effect (such as reducing the health points, weakening the attack ability, etc.) to the second player character.

According to the above manners, after the first player character and the first virtual pet are synthesized into the second virtual pet, the player may immersively experience not only the special ability possessed by the first virtual pet but also the skill possessed by the first virtual pet through the second virtual pet.

In some embodiments, the terminal may control the second virtual pet to cast the skill of the first virtual pet by following manner. In a case where the first player character is synthesized with a plurality of first virtual pets to obtain the second virtual pet, the skill combination is cast. The skill combination includes at least one skill of each first virtual pet. The skill combination is determined by following manners: it is obtained by combining a representative skill of each first virtual pet; the usage probability of each skill combination is calculated based on the characteristics of the plurality of candidate skill combinations of the plurality of first virtual pets by calling the second machine learning model, and the skill combination with the maximum usage probability is selected. The second machine learning model is trained by following manner. The second machine learning model prediction is called based on the features of a plurality of skill combination samples to obtain a probability of each skill combination, and the backpropagation is performed based on a difference between the probability of each skill combination and an actual selection result label to update the parameter of the second machine learning model.

In the practical application, in a case where the first player character is fused with a plurality of first virtual pets to obtain the second virtual pet, the skills of the first virtual pets acquired by the second virtual pet may be a skill combination obtained by combining the skills of the first virtual pets participating in the fusion transformation. For example, the first virtual pets participating in the fusion include the first virtual pet 1 having a prop picking skill, the first virtual pet 2 having a health point attenuation skill, and the first virtual pet 3 having an enemy confusing skill. Then the skill combination obtained by the synthesized second virtual pet includes the prop picking skill of the first virtual pet 1, the health point attenuation skill of the first virtual pet 2 and the enemy confusing skill of the first virtual pet 3.

When the first virtual pet participating in the fusion has a plurality of different skills, the skill combination may also be obtained by combining the representative skill selected from a plurality of skills possessed by each first virtual pet. For example, the first virtual pets participating in the fusion include the first virtual pet 1 having a prop picking skill and a prop decomposition skill (the representative skill is the prop picking skill), the first virtual pet 2 having a health point attenuation skill and an attack power attenuation skill (the representative skill is the attack power attenuation skill), and the first virtual pet 3 having an enemy confusing skill and an intelligence reduction skill (the representative skill is the enemy confusing skill), the synthesized skill combination acquired by the second virtual pet includes the prop picking skill of the first virtual pet 1, attack power attenuation skill of the first virtual pet 2 and the enemy confusing skill of first virtual pet 3.

In addition, when the first player character is fused with a plurality of first virtual pets to obtain the second virtual pet, the skills of the plurality of first virtual pets may be combined into a plurality of candidate skill combinations by permutation and combination, and the feature of each candidate skill combination (such as skill type, scene in which the skill acts, skill effective duration or cooling duration, etc.) is obtained, the second machine learning model is called to calculate the usage probability of each candidate skill combination, and the candidate skill combination with the maximum usage probability is selected as the skill combination of the synthesized second virtual pet. The second machine learning model is trained by following manner. The second machine learning model is called to perform prediction based on the features of a plurality of skill combination samples to obtain the probability of each skill combination, the backpropagation is performed based on the difference between the probability of each skill combination and the actual selection result label (for example, 1 for selection, 0 for not used) to update the parameter of the second machine learning model. For example, after the value of the loss function for the second machine learning model is determined based on the difference between the predicted probability of each skill combination sample and the actual selection result label, it may be determined whether the value of the loss function exceeds a preset threshold. When the value of the loss function exceeds the preset threshold, an error signal for the second machine learning model is determined based on the loss function. This error signal is backpropagated in the second machine learning model, the model parameter of each layer is updated during the propagation process.

It may be understood that when a plurality of first virtual pets have the same skill, the skill combination may be a simple superposition of the same skill of the first virtual pets, or may be a multiplicative superposition of the same skill of the first virtual pets.

According to the above method, after the first player character and the plurality of first virtual pets are merged and transformed into the second virtual pet, the second virtual pet further acquires the skill combination of the plurality of first virtual pets, which expands the skill range of the second virtual pet. In this way, when the interaction is performed with the skill combination based on the synthesized second virtual pet, the experience immersion of the player for the skill combination is improved.

In some embodiments, the terminal may control the second virtual pet to cast the skill of the first virtual pet by following manners. The terminal controls the second virtual pet to cast the skill of the first virtual pet, herein an attribute value of the skill of the first virtual pet cast by the second virtual pet is same as or has a second gain coefficient with respect to an attribute value of the same skill cast by the first virtual pet.

In the practical application, after the first player character and the first virtual pet are fused and transformed into the second virtual pet, so that the second virtual pet acquires the skill of the first virtual pet, an attribute value of the skill of the first virtual pet cast by the second virtual pet is same as or has a second gain coefficient (preset by the server or set by the player account corresponding to the first player object) with respect to an attribute value of the same skill cast by the first virtual pet. For example, assuming that the skill of the first virtual pet acquired by the second virtual pet is a skill that attenuates health points, if the first virtual pet casts the skill once, which may attenuate the health points of the enemy player character by 30%, the second virtual pet cast the skill once, which may attenuate the health points of the same enemy player character by 30%, or may attenuate the health point of the enemy player character by 60% (at this case, the second gain coefficient is 60%/30%=2). In this way, it is beneficial to improve the motivation of players to use the fusion transformation function.

In some embodiments, after the terminal displays the interaction picture that the second virtual pet uses the first ability for the first target scene, in response to a separation condition being satisfies, the second virtual pet is separated into the first player character and the first virtual pet. The separation condition includes any one of: receiving a separation trigger operation for the second virtual pet; the fusion duration of the first player character and the first virtual pet reaching a preset duration; the second virtual pet completing the predetermined task.

In the practical application, a certain disintegration condition may be configured to separate the second virtual pet into the first player character and the first virtual pet when the separation condition is satisfied after the first player character and the first virtual pet are synthesized into the second virtual pet. The separation condition may be that the separation trigger operation for the second virtual pet is received. That is, a separation control (such as a button for exiting the fusion) may be displayed in the virtual scene during the interaction process of the second virtual pet in the virtual scene, and when the player triggers the separation control, the terminal may receive a separation trigger operation instructing to separate the second virtual pet. The separation condition may also be set based on the interaction situation of the second virtual pet. For example, when the display duration of the second virtual pet (i.e., the fusion duration of the first player character and the first virtual pet) reaches a preset duration, it is considered that the separation condition is satisfied. For another example, when the second virtual pet completes a predetermined task (which may be a task related to the first ability preset by the server (for example, the second virtual pet completes a task related to the first ability), or a task unrelated to the first ability (for example, the interaction achievement of the second virtual pet reaches an achievement threshold), etc.), it is considered that the separation condition is satisfied.

It is to be understood that if the second virtual pet is obtained by synthesizing the first player character and a plurality of first virtual pets, when the separation is performed, the second virtual pet is separated into the first player character and a plurality of first virtual pets participating in the fusion.

The method for interaction processing in the virtual scene provided by the embodiments of the present disclosure has been described in conjunction with the exemplary applications and implementations of the electronic device provided by the embodiments of the present disclosure, the following continues to describe that the modules in the device 555 for interaction processing in the virtual scene provided by the embodiments of the present disclosure cooperate with each other to implement the interaction processing method for the virtual scene.

The first display module 5551 is configured to display a virtual scene in a human-computer interaction interface, herein the virtual scene includes a first player character. The fusion processing module 5552 is configured to, in response to a fusion operation, synthesize the first player character and a first virtual pet of the first player character into a second virtual pet having a first ability, and the first ability includes at least one of a perception ability or a movement ability of the first virtual pet. The second display module 5553 is configured to, in response to the second virtual pet being located in a first target scene corresponding to the first ability, display an interaction picture that the second virtual pet uses the first ability for the first target scene.

In some embodiments, the fusion processing module is further configured to: display a pet list, herein the pet list includes at least one first virtual pet belonging to the first player character; in response to a selection operation triggered based on the pet list, highlight the selected first virtual pet; in response to a fusion operation for the first player character and the selected first virtual pet, fuse the first player character and the selected first virtual pet into the second virtual pet having the first ability.

In some embodiments, the fusion processing module is further configured to: in a case that there are a plurality of first virtual pets, display a plurality of first virtual pets belonging to the first player character in the pet list by using the target sorting. The target order is sorted according to one of the following characteristic parameters of the first virtual pet: a historical summoning frequency, a historical fusion frequency, a matching degree between a first ability possessed by the first virtual pet and the environment in which the first player character is currently located, or an attribute value of the skill of the first virtual pet.

In some embodiments, the fusion processing module is further configured to: in a case where only one first virtual pet of the first player character is currently included in the virtual scene, synthesize the first player character and the first virtual pet currently included in the virtual scene into the second virtual pet having the first ability; in a case where a plurality of first virtual pets of the first player character are currently included in the virtual scene, in response to a pet selection operation, synthesize the first player character and the selected at least one first virtual pet into the second virtual pet having the first ability, and the first ability is the first ability of the selected at least one first virtual pet; and in a case where the first player character has a plurality of first virtual pets, fuse the first player character and the first virtual pet screened from the plurality of first virtual pets into the second virtual pet having the first ability in response to the automatic fusion operation, herein the screened first virtual pet is obtained by sorting and screening in a descending order based on the screening parameter, and the screening parameter is determined based on at least one of following characteristic parameters: a historical summoning frequency, a historical fusion frequency, a matching degree between the first ability of the first virtual pet and an environment in which the first player character is currently located, or an attribute value of the skill of the first virtual pet.

In some embodiments, the fusion processing module is further configured to: in response to an automatic fusion condition being satisfied, synthesize the first player character and the first virtual pet of the first player character into the second virtual pet having the first ability. The automatic fusion condition includes any one of followings: a use operation of the first player character for a virtual prop having a fusion function is received; an interaction operation of the first player character with a first target scene is received; the first player character moves to the first target scene and a matching degree between the first player character having the first ability and the first target scene is greater than a matching degree between the first player character not having the first ability and the first target scene; or an interaction progress of the first player character in the virtual scene reaches a first target progress.

In some embodiments, the fusion processing module is further configured to: in response to the fusion operation, synthesize the first player character and the first virtual pet of the first player character into the second virtual pet having the first ability and a first appearance. A size and a skin of the second virtual pet with the first appearance satisfy any one of following conditions: the size of the second virtual pet is greater than a size of the first virtual pet, herein a magnification of the size of the second virtual pet relative to the size of the first virtual pet represents an efficacy magnification of the second virtual pet using the first ability of the first virtual pet relative to the first ability of the first virtual pet; the skin of the second virtual pet is same as a skin of the first virtual pet; the skin of the second virtual pet is obtained by merging a skin of the first player character and the skin of the first virtual pet; or when the first player character is fused with a plurality of first virtual pets, the skin of the second virtual pet is dynamically changed with a first virtual pet to which a currently used first ability belongs.

In some embodiments, the fusion processing module is further configured to: in response to the fusion operation, display an appearance entry for configuring the appearance of the second virtual pet; in response to an appearance configuration operation triggered based on the appearance entry, configure the appearance of the second virtual pet to be a second appearance; and in response to the determining operation for the second appearance, synthesize the first player character and the first virtual pet of the first player character into the second virtual pet with the first ability and the second appearance.

In some embodiments, the fusion processing module is further configured to: in response to the trigger operation for the appearance entry, display an appearance selection interface, and display at least one candidate appearance in the appearance selection interface; and in response to the selection operation for the second appearance of the at least one candidate appearance, configure the appearance of the second virtual pet to be the second appearance.

In some embodiments, the fusion processing module is further configured to: in response to the trigger operation for the appearance entry, display an appearance configuration interface, and display at least one appearance label in the appearance configuration interface; and in response to the selection operation for the target appearance label, configure the appearance of the second virtual pet to be a second appearance generated based on the target appearance label.

In some embodiments, the fusion processing module is further configured to: in response to the fusion operation, display an ability configuration interface is displayed, and display at least one ability label in the ability configuration interface; and in response to the label selection operation, synthesize the first player character and the first virtual pet of the first player character into the second virtual pet having a first ability and a third ability, herein the third ability is the ability indicated by the selected ability label.

In some embodiments, the second display module is further configured to: in response to the first target scene being a moving scene and the first ability being a movement ability adapted to the moving scene, display a picture that the second virtual pet moves in the moving scene with the movement ability.

In some embodiments, before the first player character and the first virtual pet are synthesized into the second virtual pet having the first ability, the device further includes a third display module. The third display module is configured to: in response to the first player character being located in the first target scene, display a first view picture observed by the first player character for the first target scene. Accordingly, the second display module is further configured to: in response to the first ability being a perception ability for expanding the field of view, display a second view picture observed by the second virtual pet with the perception ability for the first target scene. The field of view of the second view picture is greater than the field of view of the first view picture.

In some embodiments, before the first player character and the first virtual pet are synthesized into the second virtual pet having the first ability, the device further includes a fourth display module. The fourth display module is configured to: in response to the first player character being located in the first target scene, display a third view picture observed by the first player character for the first target scene. Accordingly, the second display module is further configured to: in response to the first ability being a perception ability with a night vision function, display a fourth view picture observed by the second virtual pet with the perception ability for the first target scene. Herein a visibility of the third view picture is lower than a visibility of the fourth view picture.

In some embodiments, before the first player character and the first virtual pet are synthesized into the second virtual pet having the first ability, the device further includes a fifth display module. The fifth display module is configured to: in response to the first player character being located in the first target scene and there being a virtual object which is occluded in the first target scene, display a fifth view picture observed by the first player character for the first target scene. Accordingly, the second display module is further configured to: in response to the first ability being a perception ability with a detection function, display a sixth view picture that the second virtual pet uses the perception ability for the virtual object. Herein the virtual object in the fifth view picture is in an invisible state for the first player character, and the virtual object in the sixth view picture is in a visible state for the second virtual pet.

In some embodiments, the second display module is further configured to: in a case where the first player character is synthesized with a plurality of first virtual pets to obtain the second virtual pet, display an interaction picture that the second virtual pet uses the combination ability for the first target scene. The combination ability is determined by following manners: it is obtained by combining the first ability of each of the plurality of first virtual pet; it is obtained by combining a representative ability of first abilities of each of the plurality of first virtual pets; the usage probability of each combination ability is calculated for the characteristics of the plurality of candidate combination abilities of the plurality of first virtual pets by calling the first machine learning model, and the combination ability with the maximum usage probability is selected. The first machine learning model is trained by following manner. The first machine learning model prediction is called based on the features of a plurality of combination ability samples to obtain a probability of each combination ability, and the backpropagation is performed based on a difference between the probability of each combination ability and an actual selection result label to update the parameter of the first machine learning model.

In some embodiments, the second display module is further configured to display an interaction picture that the second virtual pet uses the first ability for the first target scene is displayed. Herein the efficacy that the second virtual pet uses the first ability is the same as or has a first gain coefficient with respect to the efficacy that the first virtual pet uses the first ability.

In some embodiments, after the interaction picture that the second virtual pet uses the first ability for the first target scene is displayed, the device further includes a pet updating module. The pet updating module is configured to: when the first player character has a plurality of first virtual pets, in response to a fusion update condition being satisfied, update the second virtual pet to a third virtual pet having a second ability. The third virtual pet is obtained by synthesizing the first player character with a new first virtual pet, the new first virtual pet is one of the plurality of first virtual pets, and the second ability is a first ability possessed by the new first virtual pet. The fusion update condition includes at least one of the followings: a fusion update operation is received, herein the fusion update operation indicates fusion the first player character with a new first virtual pet; the second virtual pet moves to the second target scene, and the matching degree between the second ability and the second target scene is greater than the matching degree between the first ability and the second target scene; or the interaction progress of the second virtual pet in the virtual scene reaches the second target progress, and the interaction progress includes at least one of: an interaction duration or an interaction achievement.

In some embodiments, after the first player character and the first virtual pet of the first player character are synthesized into the second virtual pet having the first ability, the device further includes a skill casting module. The skill casting module is configured to: in response to an interaction trigger operation for the second virtual pet, control the second virtual pet to cast the skill of the first virtual pet. The interaction target of the skill includes at least one of: a virtual object in the virtual scene, a non-player character in the virtual scene, or a second player character in the virtual scene, and the second player character is different from the first player character.

In some embodiments, the skill casting module is further configured to: in a case where the first player character is synthesized with a plurality of first virtual pets to obtain the second virtual pet, cast the skill combination. The skill combination includes at least one skill of each first virtual pet. The skill combination is determined by following manners: it is obtained by combining a representative skill of each first virtual pet; the usage probability of each skill combination is calculated by calling the second machine learning model for the characteristics of the plurality of candidate skill combinations of the plurality of first virtual pets, and the skill combination with the maximum usage probability is selected. The second machine learning model is trained by following manner. The second machine learning model prediction is called based on the features of a plurality of skill combination samples to obtain a probability of each skill combination, and the backpropagation is performed based on a difference between the probability of each skill combination and an actual selection result label to update the parameter of the second machine learning model.

In some embodiments, the skill casting module is further configured to control the second virtual pet to cast the skill of the first virtual pet, herein an attribute value of the skill of the first virtual pet cast by the second virtual pet is same as or has a second gain coefficient with respect to an attribute value of the same skill cast by the first virtual pet.

In some embodiments, after the interaction picture that the second virtual pet uses the first ability for the first target scene is displayed, the device further includes a separation processing module. The separation processing module is configured to: in response to a separation condition being satisfies, separate the second virtual pet into the first player character and the first virtual pet. The separation condition includes any one of: receiving a separation trigger operation for the second virtual pet; the fusion duration of the first player character and the first virtual pet reaching a preset duration; or the second virtual pet completing the predetermined task.

The embodiments of the present disclosure provide a computer program product. The computer program product includes computer instructions or computer executable instructions stored in a computer readable storage medium. The processor of the electronic device reads the computer executable instructions from the computer-readable storage medium, and the processor performs the computer executable instructions so that the electronic device performs the method for interaction processing in the virtual scene as described above in the embodiments of the present disclosure.

The embodiments of the present disclosure provide a computer-readable storage medium storing computer executable instructions or a computer program which, when performed by a processor, cause the processor to perform the method for interaction processing in a virtual scene provided by the embodiments of the present disclosure, such as the method for interaction processing in a virtual scene as illustrated in FIG. 3.

In some embodiments, the computer-readable storage medium may be a memory such as Ferroelectric Random Access Memory (FRAM), Read Only Memory (ROM), Programmable Read-Only Memory (PROM), Erasable Programmable Read-Only Memory (EPROM), Electrically Erasable Programmable Read-Only Memory (EEPROM), Flash Memory, magnetic surface memory, optical disc, or CD-ROM. It may also be one of a variety of devices including one or any combination of the above memories.

In some embodiments, the computer-executable instructions may be written in any form of programming language (including compiled or interpreted language, or declarative or procedural language) by taking the form of program, software, software module, script, or code, and may be deployed in any form, including being deployed as a standalone program or as a module, a component, a subroutine, or other units suitable for use in the computing environment.

As an example, the computer-executable instructions may, but do not necessarily correspond to a file in the file system, and may be stored as part of a file storing other programs or data, such as stored in one or more scripts stored in a Hyper Text Markup Language (HTML) document, in a single file dedicated to the discussed program, or in multiple collaborative files (e.g., files storing one or more modules, subroutines, or code part).

As an example, the computer-executable instructions may be deployed to be performed in one electronic device, or in multiple electronic devices located at a same location, or in multiple electronic devices distributed across multiple locations and interconnected by the communication network.

By applying the embodiments of the present disclosure, at least the following technical effects are obtained.
1) Immersive experience: the player may experience the virtual scene more deeply, and explore the environment in the virtual scene from the perspective of the virtual pet, and the realism and immersion of interaction in the virtual scene are increased.
2) Character diversity: after the fusion and transformation, the ability and skill of the player are expanded, and the player may perform different tasks and actions in the form of virtual pet, thereby increasing the diversity and flexibility of the player characters.
3) Enhanced perception ability: according to the characteristics of virtual pets, the player may obtain the special perception abilities such as night vision, keen sense of smell, and sensitive hearing. These abilities may help players discover hidden props or where the enemies are.
4) New skills and battle strategies: the player may acquire skills and abilities unique to the virtual pets, such as sneaking, fast movement, special attacks, etc., which may provide new strategies and advantages in battles.
5) Exploration and discovery: in the form of virtual pets, the player may enter the areas that are inaccessible previously and discover new clues, props or tasks.
6) Emotional link: the fusion and transformation may enhance the emotional connection between the player and the virtual pet, and increase the loyalty and concern of the player for the virtual pet.

The descriptions above are only embodiments of the present disclosure, and are not intended to limit the scope of present disclosure. Any modification, equivalent replacement and improvement made within the spirit and scope of the present disclosure all fall within the protection scope of the present disclosure.

1. A method for interaction processing in a virtual scene, comprising:
displaying a virtual scene in a human-computer interaction interface, wherein the virtual scene comprises a first player character;
in response to a fusion operation, synthesizing the first player character and a first virtual pet of the first player character into a second virtual pet having a first ability, wherein the first ability comprises at least one of a perception capability or a movement ability of the first virtual pet; and
in response to the second virtual pet being located in a first target scene corresponding to the first ability, displaying an interaction picture that the second virtual pet uses the first ability for the first target scene.

2. The method of claim 1, wherein in response to the fusion operation, synthesizing the first player character and the first virtual pet of the first player character into the second virtual pet having the first ability comprises:
displaying a pet list, wherein the pet list comprises at least one first virtual pet belonging to the first player character;
in response to a selection operation triggered based on the pet list, highlighting a selected first virtual pet; and
in response to a fusion operation for the first player character and the selected first virtual pet, fusing the first player character and the selected first virtual pet into the second virtual pet having the first ability.

3. The method of claim 1, wherein in response to the fusion operation, synthesizing the first player character and the first virtual pet of the first player character into the second virtual pet having the first ability comprises:
in response to an automatic fusion condition being satisfied, synthesizing the first player character and the first virtual pet of the first player character into the second virtual pet having the first ability, wherein the automatic fusion condition comprises one of followings:
a use operation performed by the first player character for a virtual prop having a fusion function is received;
an interaction operation of the first player character with a first target scene is received;
the first player character moves to the first target scene and a matching degree between the first player character having the first ability and the first target scene is greater than a matching degree between the first player character not having the first ability and the first target scene; or
an interaction progress of the first player character in the virtual scene reaches a first target progress.

4. The method of claim 1, wherein in response to the fusion operation, synthesizing the first player character and the first virtual pet of the first player character into the second virtual pet having the first ability comprises:
in response to the fusion operation, synthesizing the first player character and the first virtual pet of the first player character into the second virtual pet having the first ability and a first appearance, wherein a size and a skin of the second virtual pet with the first appearance satisfy one of followings:
the size of the second virtual pet is greater than a size of the first virtual pet, wherein a magnification of the size of the second virtual pet relative to the size of the first virtual pet represents an efficacy magnification of the second virtual pet using the first ability of the first virtual pet relative to the first ability of the first virtual pet;
the skin of the second virtual pet is same as a skin of the first virtual pet;
the skin of the second virtual pet is obtained by merging a skin of the first player character and the skin of the first virtual pet; or
when the first player character is fused with a plurality of first virtual pets, the skin of the second virtual pet is dynamically changed with a first virtual pet to which a currently used first ability belongs.

5. The method of claim 1, wherein displaying the interaction picture that the second virtual pet uses the first ability for the first target scene comprises:
in response to the first target scene being a moving scene and the first ability being a movement ability adapted to the moving scene, displaying a picture that the second virtual pet moves in the moving scene with the movement ability.

6. The method of claim 1, before synthesizing the first player character and the first virtual pet into the second virtual pet having the first ability, further comprising:
in response to the first player character being located in the first target scene, displaying a first view picture observed by the first player character for the first target scene;
wherein displaying the interaction picture that the second virtual pet uses the first ability for the first target scene comprises:
in response to the first ability being a perception ability for expanding a field of view, displaying a second view picture observed by the second virtual pet by using the perception ability for the first target scene;
wherein a field of view of the second view picture is larger than a field of view of the first view picture.

7. The method of claim 1, before synthesizing the first player character and the first virtual pet into the second virtual pet having the first ability, further comprising:
in response to the first player character being located in the first target scene, displaying a third view picture observed by the first player character for the first target scene;
wherein displaying the interaction picture that the second virtual pet uses the first ability for the first target scene comprises:
in response to the first ability being a perception ability with a night vision function, displaying a fourth view picture observed by the second virtual pet by using the perception ability for the first target scene;
wherein a visibility of the third view picture is lower than a visibility of the fourth view picture.

8. The method of claim 1, before synthesizing the first player character and the first virtual pet into the second virtual pet having the first ability, further comprising:
in response to the first player character being located in the first target scene and there being a virtual object which is occluded in the first target scene, displaying a fifth view picture observed by the first player character for the first target scene;
wherein displaying the interaction picture that the second virtual pet uses the first ability for the first target scene comprises:
in response to the first ability being a perception ability with a detection function, displaying a sixth view picture observed by the second virtual pet by using the perception ability for the virtual object;
wherein the virtual object in the fifth view picture is in an invisible state for the first player character, and the virtual object in the sixth view picture is in a visible state for the second virtual pet.

9. The method of claim 1, wherein displaying the interaction picture that the second virtual pet uses the first ability for the first target scene comprises:
in a case where the first player character is fused with a plurality of first virtual pets to obtain the second virtual pet, displaying an interaction picture that the second virtual pet uses a combination ability for the first target scene, wherein the combination ability is determined by following manners:
it is obtained by combining a first ability of each of the plurality of first virtual pets;
it is obtained by combining a representative ability of first abilities of each of the plurality of first virtual pets; or
based on characteristics of a plurality of candidate combination abilities of the plurality of first virtual pets, a usage probability of each of the plurality of candidate combination abilities is calculated by calling a first machine learning model, and a combination capability with a maximum usage probability is selected; wherein the first machine learning model is trained by following manner:
based on characteristics of a plurality of combination ability samples, prediction is performed by calling the first machine learning model to obtain a probability of each combination ability, and backpropagation is performed based on a difference between the probability of each combination ability and an actual selection result label to update parameters of the first machine learning model.

10. The method of claim 1, wherein in response to the fusion operation, synthesizing the first player character and the first virtual pet of the first player character into the second virtual pet having the first ability comprises:
in response to the fusion operation, displaying an ability configuration interface, and displaying at least one ability label in the ability configuration interface; and
in response to a label selection operation, synthesizing the first player character and the first virtual pet of the first player character into the second virtual pet having the first ability and a third ability, wherein the third ability is an ability indicated by at least one selected ability label.

11. The method of claim 1, after displaying the interaction picture that the second virtual pet uses the first ability for the first target scene, further comprising:
in a case where the first player character has a plurality of first virtual pets, in response to a fusion update condition being satisfied, updating the second virtual pet to a third virtual pet having a second ability;
wherein the third virtual pet is obtained by synthesizing the first player character with a new first virtual pet, the new first virtual pet is one of the plurality of first virtual pets, and the second ability is a first ability possessed by the new first virtual pet; and
the fusion update condition includes at least one of followings:
a fusion update operation is received, wherein the fusion update operation indicates fusing the first player character with a new first virtual pet;
the second virtual pet moves to a second target scene, and a matching degree between the second ability and the second target scene is greater than a matching degree between the first ability and the second target scene; or
an interaction progress of the second virtual pet in the virtual scene reaches a second target progress, wherein the interaction progress includes at least one of: an interaction duration or an interaction achievement.

12. A device for interaction processing in a virtual scene, comprising:
a memory for storing a computer program; and
a processor, configured to, when performing the computer program stored in the memory, implement a method for interaction processing in a virtual scene;
wherein the method comprises:
displaying a virtual scene in a human-computer interaction interface, wherein the virtual scene comprises a first player character;
in response to a fusion operation, synthesizing the first player character and a first virtual pet of the first player character into a second virtual pet having a first ability, wherein the first ability comprises at least one of a perception capability or a movement ability of the first virtual pet; and
in response to the second virtual pet being located in a first target scene corresponding to the first ability, displaying an interaction picture that the second virtual pet uses the first ability for the first target scene.

13. The device of claim 12, wherein in response to the fusion operation, synthesizing the first player character and the first virtual pet of the first player character into the second virtual pet having the first ability comprises:
displaying a pet list, wherein the pet list comprises at least one first virtual pet belonging to the first player character;
in response to a selection operation triggered based on the pet list, highlighting a selected first virtual pet; and
in response to a fusion operation for the first player character and the selected first virtual pet, fusing the first player character and the selected first virtual pet into the second virtual pet having the first ability.

14. The device of claim 12, wherein in response to the fusion operation, synthesizing the first player character and the first virtual pet of the first player character into the second virtual pet having the first ability comprises:
in response to an automatic fusion condition being satisfied, synthesizing the first player character and the first virtual pet of the first player character into the second virtual pet having the first ability, wherein the automatic fusion condition comprises one of followings:
a use operation performed by the first player character for a virtual prop having a fusion function is received;
an interaction operation of the first player character with a first target scene is received;
the first player character moves to the first target scene and a matching degree between the first player character having the first ability and the first target scene is greater than a matching degree between the first player character not having the first ability and the first target scene; or
an interaction progress of the first player character in the virtual scene reaches a first target progress.

15. The device of claim 12, wherein in response to the fusion operation, synthesizing the first player character and the first virtual pet of the first player character into the second virtual pet having the first ability comprises:
in response to the fusion operation, synthesizing the first player character and the first virtual pet of the first player character into the second virtual pet having the first ability and a first appearance, wherein a size and a skin of the second virtual pet with the first appearance satisfy one of followings:
the size of the second virtual pet is greater than a size of the first virtual pet, wherein a magnification of the size of the second virtual pet relative to the size of the first virtual pet represents an efficacy magnification of the second virtual pet using the first ability of the first virtual pet relative to the first ability of the first virtual pet;
the skin of the second virtual pet is same as a skin of the first virtual pet;
the skin of the second virtual pet is obtained by merging a skin of the first player character and the skin of the first virtual pet; or
when the first player character is fused with a plurality of first virtual pets, the skin of the second virtual pet is dynamically changed with a first virtual pet to which a currently used first ability belongs.

16. The device of claim 12, wherein displaying the interaction picture that the second virtual pet uses the first ability for the first target scene comprises:
in response to the first target scene being a moving scene and the first ability being a movement ability adapted to the moving scene, displaying a picture that the second virtual pet moves in the moving scene with the movement ability.

17. The device of claim 12, before synthesizing the first player character and the first virtual pet into the second virtual pet having the first ability, further comprising:
in response to the first player character being located in the first target scene, displaying a first view picture observed by the first player character for the first target scene;
wherein displaying the interaction picture that the second virtual pet uses the first ability for the first target scene comprises:
in response to the first ability being a perception ability for expanding a field of view, displaying a second view picture observed by the second virtual pet by using the perception ability for the first target scene;
wherein a field of view of the second view picture is larger than a field of view of the first view picture.

18. The device of claim 12, before synthesizing the first player character and the first virtual pet into the second virtual pet having the first ability, further comprising:
in response to the first player character being located in the first target scene, displaying a third view picture observed by the first player character for the first target scene;
wherein displaying the interaction picture that the second virtual pet uses the first ability for the first target scene comprises:
in response to the first ability being a perception ability with a night vision function, displaying a fourth view picture observed by the second virtual pet by using the perception ability for the first target scene;
wherein a visibility of the third view picture is lower than a visibility of the fourth view picture.

19. The device of claim 12, before synthesizing the first player character and the first virtual pet into the second virtual pet having the first ability, further comprising:
in response to the first player character being located in the first target scene and there being a virtual object which is occluded in the first target scene, displaying a fifth view picture observed by the first player character for the first target scene;
wherein displaying the interaction picture that the second virtual pet uses the first ability for the first target scene comprises:
in response to the first ability being a perception ability with a detection function, displaying a sixth view picture observed by the second virtual pet by using the perception ability for the virtual object;
wherein the virtual object in the fifth view picture is in an invisible state for the first player character, and the virtual object in the sixth view picture is in a visible state for the second virtual pet.

20. A non-transitory computer-readable storage medium having a computer program stored thereon, wherein the computer program, when performed by a processor, cause the processor to perform a method for interaction processing in a virtual scene; and the method comprises:
displaying a virtual scene in a human-computer interaction interface, wherein the virtual scene comprises a first player character;
in response to a fusion operation, synthesizing the first player character and a first virtual pet of the first player character into a second virtual pet having a first ability, wherein the first ability comprises at least one of a perception capability or a movement ability of the first virtual pet; and
in response to the second virtual pet being located in a first target scene corresponding to the first ability, displaying an interaction picture that the second virtual pet uses the first ability for the first target scene.
